(19) United States
(12) Patent Application Publication
(10) Pub. No.: US 2026/0347257 A1
(43) Pub. Date: Nov. 5, 2026

(54) METHODS AND SYSTEMS FOR IMPROVING CARBON SEQUESTRATION AND THERMAL STIFFENING IN CEMENTITIOUS COMPOSITES

(71) Applicants: The Regents of the University of California, Oakland, CA (US); Technical University of Munich, Munich (DE)

(72) Inventors: Gaurav Sant, Los Angeles, CA (US); Xiaodi Dai, Los Angeles, CA (US); Sharu Bhagavathi, Los Angeles, CA (US); Samanvaya Srivastava, Los Angeles, CA (US); Torben Gädt, Traunstein (DE)

(21) Appl. No.: 19/663,581

(22) Filed: Apr. 30, 2026

Related U.S. Application Data
(60) Provisional application No. 63/797,609, filed on Apr. 30, 2025.

(51) Int. Cl. C04B 28/04; B01D 53/62; B01D 53/81; B28B 1/00; B33Y 10/00; B33Y 30/00; B33Y 70/00; C04B 22/06; C04B 28/02; C04B 40/00; C04B 111/00

(52) U.S. Cl. CPC C04B 28/04; B33Y 30/00; B33Y 70/00; C04B 22/062; C04B 28/021; C04B 40/0042; C04B 40/0075; B01D 53/62; B01D 53/81; B01D 2257/504; B28B 1/001; B33Y 10/00; C04B 2111/00019; C04B 2111/00181

(57) ABSTRACT

The present disclosure relates to thermo-responsive suspensions for improved carbon sequestration and thermal stiffening. The disclosure further relates to methods of producing said suspensions, and a 3D-printing system.

### CROSS-REFERENCE TO RELATED APPLICATIONS

This application claims the benefit of U.S. Provisional Application No. 63/797,609, filed Apr. 30, 2025, the contents of which are incorporated herein in their entirety by this reference.

### BACKGROUND

The sustainability of 3D printing in construction using Ordinary Portland Cement (OPC) remains under debate, largely due to the increased binder content required for digitally fabricated concrete compared to traditional cast-in-place methods. This concern underscores the urgent need to explore more sustainable binders as alternatives to conventional OPC. Accordingly, improved cement formulations are needed to facilitate 3D printing methods.

### SUMMARY OF THE INVENTION

In certain aspects, the present disclosure provides methods of producing a 3D-printed concrete product, comprising:
preparing a thermo-responsive suspension comprising a binder and an alkaline solution;
extruding the thermo-responsive suspension under controlled heating, thereby producing a 3D-printed structural component; and
curing the 3D-printed structural component, thereby producing a 3D-printed concrete product.

In further aspects, the present disclosure provides thermo-responsive suspensions comprising
a binder; and
an alkaline solution at alkaline solution concentration,
wherein the alkaline solution and the binder in the thermos-responsive suspension have a mass ratio from about 0.2 to about 1; and
wherein the alkaline solution concentration is between about 4 molar to about 12 molar.

In yet further aspects, the present disclosure provides 3D-printing systems comprising: a cementitious suspension feed;
an auger body;
a motor;
an extruder;
one or more heating elements; and
a nozzle head comprising a nozzle.

### BRIEF DESCRIPTION OF THE DRAWINGS

FIG. 1 shows an embodiment of a custom-built 3D-printing system.

FIG. 2A shows representative flow curves and time-sweep SAOS measurements of CH-FA suspensions at room temperature (25 °C). The flow curves of CH-FA suspensions (8M-NaOH and S/B=0.44) indicate rising yield stress with increasing CH to FA replacement rates of 0%, 10%, 20%, and 30%.

FIG. 2B shows the flow curves of the CH-FA suspension (20CH+80% FA and S/B=0.44) exhibiting increasing yield stress with increasing NaOH concentration from OM to 12M.

FIG. 2C shows the flow curves of the CH-FA suspension (8M-NaOH, 20CH80FA) presenting increasing yield stress with decreasing S/B from 0.44 to 0.36.

FIG. 2D shows the evolution of structural build-up of CHFA suspension at room temperature with different amounts of CH ranging from 0% to 50%.

FIG. 2E shows the evolution of structural build-up of CH-FA suspensions at room temperature with different concentrations of NaOH over the range of OM-12M.

FIG. 2F shows the evolution of structural build-up of CH-FA suspension at room temperature with different S/B ranging from 0.44 to 0.36.

FIG. 3A shows temperature-sweep SAOS measurements of CH-FA suspensions over the temperature range from 25 °C to 90 °C. Stiffening process of CH-FA suspension (8M-NaOH and S/B=0.44) with increasing temperature and increasing CH replacement: 0%, 10%, 20%, 30% and 50% CH.

FIG. 3B shows temperature-sweep SAOS measurements of CH-FA suspensions over the temperature range from 25 °C to 90 °C. Stiffening process of CH-FA suspension (20CH+80FA and S/B=0.44) with increasing temperature and NaOH concentration from OM to 12M.

FIG. 3C shows temperature-sweep SAOS measurements of CH-FA suspensions over the temperature range from 25 °C to 90 °C. Stiffening process of CH-FA suspensions (20CH+80FA and NaOH-8M) with increasing temperature for different S/B from 0.36 to 0.44.

FIG. 4A shows the evolution of stiffening process, reaction kinetics, pore solution chemistry and effective saturation indices of CH-FA suspension over the temperature range from 25 °C to 90 °C. The temperature-sweep SAOS measurements of 100FA and 20CH80FA suspensions.

FIG. 4B shows the evolution of stiffening process, reaction kinetics, pore solution chemistry and effective saturation indices of CH-FA suspension over the temperature range from 25 °C to 90 °C. The correlation between the structural build-up and reaction kinetics examined using DSC for 100FA suspension.

FIG. 4C shows the evolution of stiffening process, reaction kinetics, pore solution chemistry and effective saturation indices of CH-FA suspension over the temperature range from 25 °C to 90 °C. The correlation between the structural build-up and reaction kinetics examined using DSC for 20CH80FA suspension.

FIG. 4D shows the evolution of stiffening process, reaction kinetics, pore solution chemistry and effective saturation indices of CH-FA suspension over the temperature range from 25 °C to 90 °C. The evolution of the pore solution chemistry evolution of the 100FA and 20CH80FA suspensions.

FIG. 4E shows the evolution of stiffening process, reaction kinetics, pore solution chemistry and effective saturation indices of CH-FA suspension over the temperature range from 25 °C to 90 °C. The calculated effective saturation index based on pore solution chemistry of the 100 FA and 20CH80FA suspensions.

FIG. 5A shows representative isothermal calorimetry curves of the CH-FA suspension up to 7 d. The heat flow of a CH-FA suspension (8M-NaOH, s/b=0.44) with varying amounts of CH addition from 0-to-50 mass %.

FIG. 5B shows representative isothermal calorimetry curves of the CH-FA suspension up to 7 d. The cumulative heat release of a CH-FA suspension (8M-NaOH, s/b=0.44) with varying amounts of CH addition from 0-to-50 mass %.

FIG. 5C shows representative isothermal calorimetry curves of the CH-FA suspension up to 7 d. The heat flow of a CH-FA suspension (20CH+80FA and S/B=0.44) across varying NaOH concentrations from 0 M to 12 M.

FIG. 5D shows representative isothermal calorimetry curves of the CH-FA suspension up to 7 d. The cumulative heat release of a CH-FA suspension (20CH+80FA and S/B=0.44) across varying NaOH concentrations from 0 M to 12 M.

FIG. 5E shows representative isothermal calorimetry curves of the CH-FA suspension up to 7 d. The heat flow of CH-FA suspensions (8M-NaOH and 20CH+80FA) with different 0.36≤s/b≤0.44.

FIG. 5F shows representative isothermal calorimetry curves of the CH-FA suspension up to 7 d shows the cumulative heat release of CH-FA suspensions (8M-NaOH and 20CH+80FA) with different 0.36≤s/b≤0.44.

FIG. 6A shows the compressive strength of the CH-FA mixtures after 2 d and 7 d of aging, showing the effects of CH addition, NaOH concentration and s/b. In general, the samples “sealed cured” at 65 °C for 2 d and 7 d prior to compression testing.

FIG. 6B shows the relationship between compressive strength and cumulative heat release.

FIG. 7A shows solid phase analysis of the reaction products using TGA. Indicated here are Mu—mullite, Hg—hydrogarnet (C3AH6), P—portlandite, H—hematite, Q—quartz, CASH—calcium aluminosilicate hydrate, Z—zeolite (sodium aluminosilicate hydrate), C—calcite, Zn—zinc oxide, Ma—Magnetite.

FIG. 7B shows solid phase analysis of the reaction products using XRD. Indicated here are Mu—mullite, Hg—hydrogarnet (C3AH6), P—portlandite, H—hematite, Q—quartz, CASH—calcium aluminosilicate hydrate, Z—zeolite (sodium aluminosilicate hydrate), C—calcite, Zn—zinc oxide, Ma—Magnetite.

FIG. 7C shows the phase assemblage of the CH-FA mixture after 1 d, 2 d, and 7 d of aging as estimated by quantitative XRD. In general, the samples “sealed cured” at 65 °C prior to the analysis.

FIG. 8A shows the demonstration of 3D printing works with the mixture 20CH80FA. The layer thickness is 3 mm. Printing speed is 25 mm/s. The height is 120 mm and the distance between the diagonal vertices is 130 mm.

FIG. 8B shows the demonstration of 3D printing works with the mixture 20CH80FA. The layer thickness is 3 mm. Printing speed is 25 mm/s. The height is 120 mm and the distance between the diagonal vertices is 130 mm.

FIG. 8C shows the demonstration of 3D printing works with the mixture 20CH80FA. The layer thickness is 3 mm. Printing speed is 25 mm/s. The height is 100 mm and the side length of bottom triangle is 55 mm.

FIG. 8D shows the demonstration of 3D printing works with the mixture 20CH80FA. The layer thickness is 3 mm. Printing speed is 25 mm/s. The height is 100 mm and the side length of bottom triangle is 55 mm.

FIG. 8E shows the demonstration of 3D printing works with the mixture 20CH80FA. The layer thickness is 3 mm. Printing speed is 25 mm/s. The height is 200 mm and the diameter of the bottom circle is 55 mm.

FIG. 8F shows the demonstration of 3D printing works with the mixture 20CH80FA. The layer thickness is 3 mm. Printing speed is 25 mm/s. The height is 200 mm and the diameter of the bottom circle is 55 mm.

FIG. 8G shows the demonstration of 3D printing works with the mixture 20CH80FA. The layer thickness is 3 mm. Printing speed is 25 mm/s. The side length of the cube is 100 mm.

FIG. 8H shows the demonstration of 3D printing works with the mixture 20CH80FA. The layer thickness is 3 mm. Printing speed is 25 mm/s. The side length of the cube is 100 mm.

FIG. 8I shows the demonstration of 3D printing works with the mixture 20CH80FA. The layer thickness is 3 mm. Printing speed is 25 mm/s. The height is 170 mm and the diameter of the bottom circle is 100 mm.

FIG. 9A shows flow curves of CH-FA suspension with thermo-responsive polymer at room temperature (25 °C). The flow curves of the CH-FA suspension (φ=0.5) show decreasing yield stress and plastic viscosity with the increasing replacement of 0%, 10%, 20% and 50% FA to CH.

FIG. 9B shows the flow curves of CH-FA suspension with thermo-responsive polymer at room temperature (25 °C). The flow curves of the CH-FA suspension (50% CH+50% FA) show decreasing yield stress and plastic viscosity with the increasing φ ranging from 0.5 to 0.7.

FIG. 9C shows small amplitude oscillation shear (SAOS) tests with time of CH-FA suspension with thermo-responsive polymer at room temperature (25 °C). The SAOS tests with time of the CH-FA suspension (φ=0.5) showing decreasing yield stress and plastic viscosity with the increasing replacement of 0%, 10%, 20% and 50% FA to CH.

FIG. 9D shows small amplitude oscillation shear (SAOS) tests with time of CH-FA suspension with thermo-responsive polymer at room temperature (25 °C). The SAOS tests with time of the CH-FA suspension (50% CH+50% FA) showing decreasing yield stress and plastic viscosity with the increasing φ ranging from 0.5 to 0.7.

FIG. 10A shows small amplitude oscillatory shear results with temperature for different thermo-responsive suspension formulations comprising different fly ash addition.

FIG. 10B shows variation in stiffening rate of thermo-responsive suspensions across different fly ash addition.

FIG. 10C shows small amplitude oscillatory shear results with temperature for different thermo-responsive suspension formulations comprising different solid binder content, p.

FIG. 10D shows variation in stiffening rate of thermo-responsive suspensions across different solid binder content. The heating rate is 2 °C/min between the temperature range of 25 °C to 90 °C (Note: thermo-responsive monomers dosage, ρρ=10 w %; molar ratio of monomer to crosslinker is 100, molar ratio of monomer to initiator is 200).

FIG. 11A shows reaction kinetics of monomers dispersed in CH-FA suspension. Heat flow of CH-FA suspension with the replacement of 0%, 10%, 20%, and 50% FA to CH. The heating rate is 2 °C/min between the temperature range of 25 °C to 90 °C (Note: thermo-responsive monomers dosage, ρ=10 w %; molar ratio of monomer to crosslinker is 100, molar ratio of monomer to initiator is 200).

FIG. 11B shows reaction kinetics of monomers dispersed in CH-FA suspension. Heat flow of CH-FA suspension with different φ ranging from 0.5 to 0.7. The heating rate is 2 °C/min between the temperature range of 25 °C to 90 °C (Note: thermo-responsive monomers dosage, ρ=10 w %; molar ratio of monomer to crosslinker is 100, molar ratio of monomer to initiator is 200).

FIG. 12A shows thermogravimetry analysis (TGA) curves of CH-FA mixtures at 7 d. TGA of CH-FA suspension with the replacement of 0%, 10%, 20%, and 50% FA to CH at 7 d.

FIG. 12B shows Differential thermogravimetry (DTG) curves of CH-FA mixtures at 7 d. DTG of CH-FA suspension with the replacement of 0%, 10%, 20%, and 50% FA to CH at 7 d.

FIG. 12C shows Differential thermogravimetry (DTG) curves of CH-FA mixtures at 7 d. TGA of CH-FA suspension with different φ ranging from 0.5 to 0.7 at 7 d.

FIG. 12D shows Differential thermogravimetry (DTG) curves of CH-FA mixtures at 7 d. DTG of CH-FA suspension with different φ ranging from 0.5 to 0.7 at 7 d.

FIG. 12E shows the calculation results of CO₂ uptake based on the TGA/DTG data. The sample was equilibrated at 35 °C for 5 min before being subjected to a heating rate of 15 °C/min between the temperature range of 35 °C to 1000 °C. Mass loss (Thermogravimetry, TG) and its derivative (DTG) were utilized to characterize and quantify several phases of reaction products, such as calcium silicate hydrate, CH, calcium carbonate, etc. CH and calcium carbonate were quantified via thermogravimetric analysis (TGA) using a tangent method. The quantification was based on weight loss in the temperature range of approximately 400 °C-520 °C and 600 °C-900 °C for CH and calcium carbonate, respectively. Weight loss due to the decarbonation of calcium carbonate was used to quantify calcium carbonate (% CC, Eq. (1)). Given the adequate presence of CH in the mixtures, carbonation of less potential reaction products (C—S—H) seemed less at early ages. The calculation of CO₂ uptake

$$( \frac{gCO 2}{gCH} )$$

represents the efficiency of CO₂ adsorption by CH (Eq. (2)). The weight loss percentage was calculated by dividing the weight loss by the residual weight at 1000 °C. The percentage values shown on the y-axis in the DTG curves were obtained from the initial sample weight:

$$\% CC = \frac{{ML}_{CC} {xm}_{CC}}{{m}_{{CO}_{2}}} \qquad ( 2 )$$

$${CO}_{2} uptake ( \frac{{g}_{{CO}_{2}}}{{g}_{CH}} ) = \frac{\% CC}{\% {CH}_{original}} \qquad ( 3 )$$

where ML_{CC} represents the mass loss percentages resulting from the decarbonation of calcium carbonate. m_{CC} is molecular masses of calcium carbonate, m_{CO2} is the molecular mass of CO₂. % CH_{original} is the mass fraction of CH in the original mixture (only binder solids and polymers, excluding water),

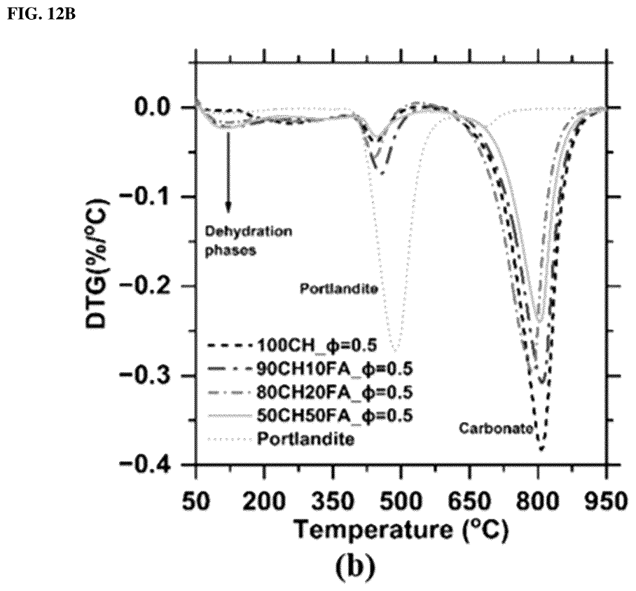

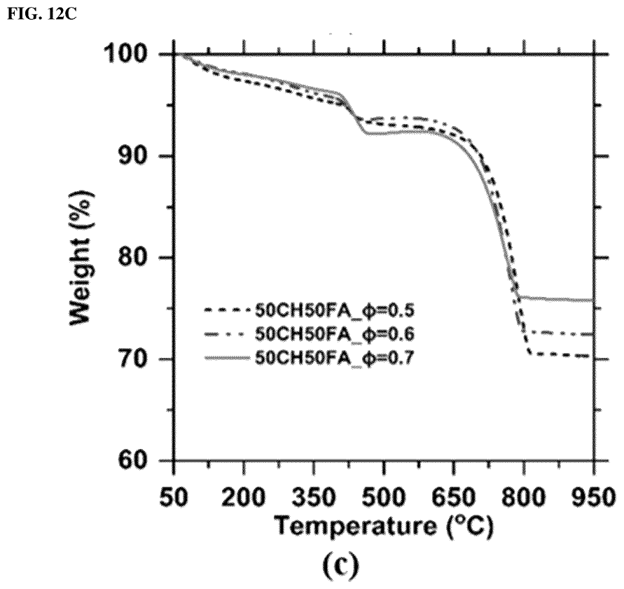

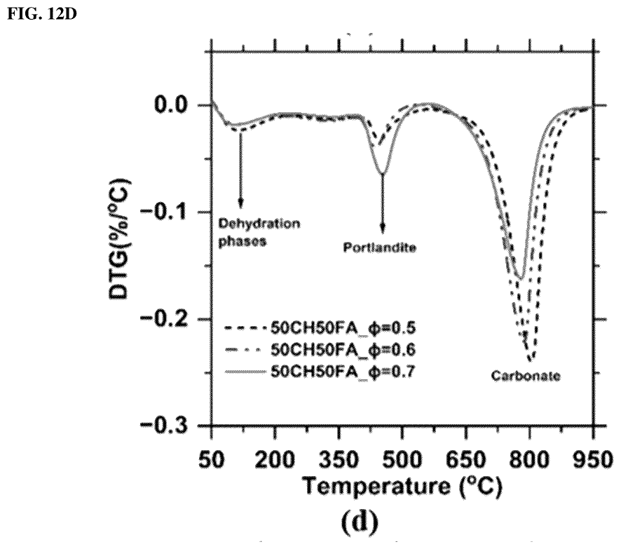

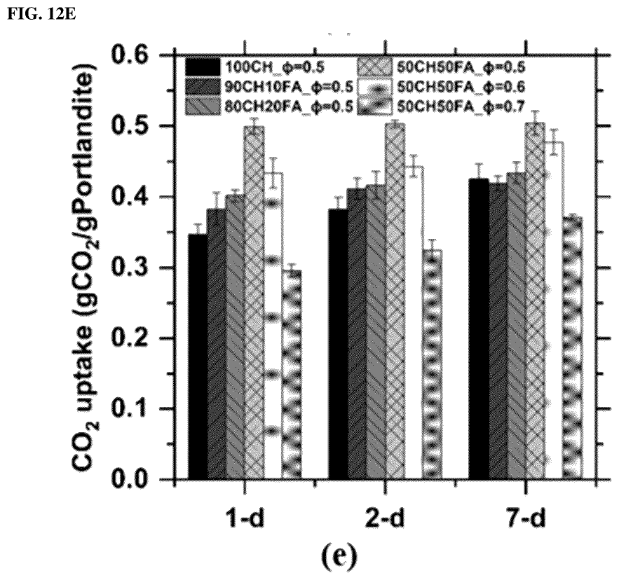

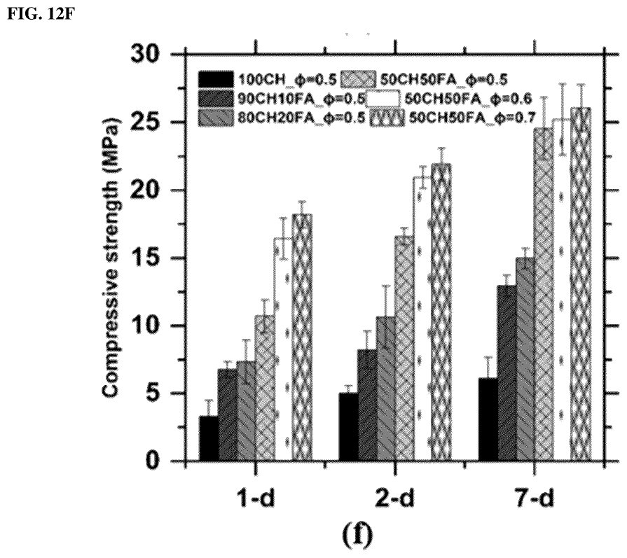

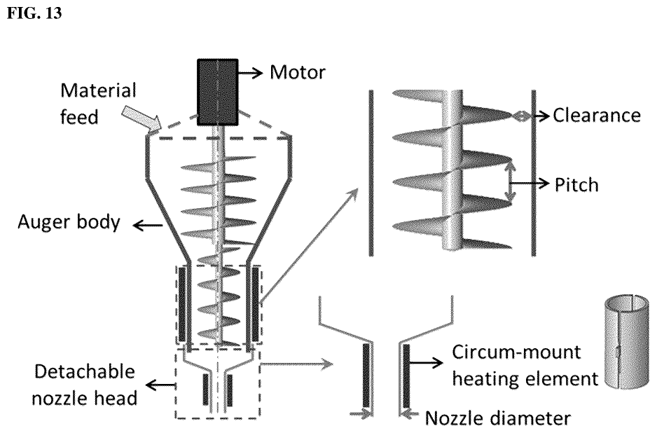

FIG. 12F shows the compressive strength of CH-FA mixture with thermo-responsive polymer.

FIG. 13 shows a schematic representation of the extruder and heating setup.

### DETAILED DESCRIPTION OF THE INVENTION

One approach involves using supplementary cementitious materials (SCM) like slag, fly ash, and silica fume. Another viable strategy is to adopt low-carbon binders, such as alkali-activated materials. The alkali activation of fly ash (FA) to produce construction materials is a promising avenue for enhancing industrial waste utilization and reducing carbon emission. In parallel, using low-carbon binders for concrete 3D-printing provides numerous benefits, including increased sustainability, improved construction quality, enhanced productivity, and greater geometric flexibility. Therefore, employing low-carbon binders with utilization of FA activation is desirable in 3D-printing. The main obstacle to advancing FA-based printable formulations is the low rate of structural build-up during curing and inadequate mechanical properties in the hardened state due to the low reactivity of FA. To improve the early structural build-up of alkali-activated fly ash (AAF) mixtures, portlandite (Ca(OH)₂, CH) can be incorporated. Past research has demonstrated that adding CH to FA-based mixtures activated by various agents significantly enhances structure formation and reduces fluidity. For instance, Zhao et al. found that adding 2%-15% CH to AAF mixtures, activated with 8M NaOH, decreased fluidity by 8%-41%. When a 2M sodium silicate solution was used as an activator, incorporating 1%-7% CH reduced fluidity by 4%-49%. Similarly, Banchhor et al. observed that replacing FA with 20% CH in AAF concrete, activated with NaOH and calcium silicate, reduced fluidity. Nath et al. showed that partially substituting FA with 2% CH in AAF mortar mixtures, activated with NaOH and sodium silicate, achieved shorter setting times as compared with AAF mixtures. The addition of CH reduces fluidity/setting times by enhancing dissolution of precursors, accelerating hydration and promoting the formation of C—S—H, which shifts free water into bound water. The enhancement of mechanical performance in the service can be attained by optimized formulations containing CH. Chindaprasirt et al. examined AAF pastes activated with NaOH and sodium silicate, replacing FA with 5-15% CH followed by curing at ambient temperature. This replacement enhanced the 7-day compressive strength up to 60% for a dosage of up to 15% CH, with corresponding 28-day strength increases of up to 45%. Similarly, Dombrowski et al. indicated that 4% CH addition into NaOH activated AAF mixtures cured at 40 °C reduced the 28-day compressive strength by 12%, while 14% and 20% additions led to strength increases of approximately 1.8 and 3 times, respectively. Hoyos-Montilla et al. reported that the addition of CH in the FA-based mixtures results in denser microstructures due to the formation of C-(A)-S—H type cementing gels and the incorporation of sodium in N-A-S—H type gel. The enhanced strength is because CH could potentially engage in the reaction, likely through a pozzolanic mechanism upon reacting with FA within an alkaline environment. Additionally, CH serves as nucleation sites, augmenting the reaction pace during the dormant phase, and partakes in the generation of reaction products in the presence of NaOH.

The present disclosure describes a design methodology for enhancing the carbon capture capacity and active thermal stiffening control of concentrated cementitious suspensions. The methodology integrates carbon dioxide (CO₂) mineralization processes with 3D printing techniques to produce advanced construction materials characterized by rapid stiffening, improved mechanical performance, and reduced carbon emissions. The present disclosure provides a design methodology for developing 3D-printable portlandite-fly ash suspensions with enhanced CO₂ sequestration potential, comprising: Formulating a thermo-responsive cementitious suspension incorporating fly ash to improve pumpability and extend open time for 3D printing applications; Applying controlled heating at the print nozzle to induce rapid stiffening during extrusion; And subjecting the printed structural component to a CO₂-rich environment for post-curing to achieve further strengthening. The inclusion of fly ash in the formulation addresses the limitations of pumpability in concentrated portlandite suspensions and facilitates prolonged workability. The thermo-responsive free radical polymerization enables a controlled early stiffening rate, ensuring printability of portlandite-rich slurries. Further, the printed structures finally achieve adequate strength through portlandite carbonation and the pozzolanic reaction of fly ash during post-curing under CO₂ exposure and elevated temperatures. This formulation comprising portlandite, fly ash, and thermo-responsive additives (e.g., monomers, crosslinkers and initiators) enables the production of sustainable construction materials with an optimized strength-to-weight ratio. Moreover, it expands the scope of design and production possibilities for creating intricate and topologically optimized structural components for the construction industry using 3D printing technologies. The present application describes a design methodology aimed at enhancing carbon capture efficiency and printability of thermo-responsive portlandite-fly ash suspensions, as summarized below:

1. The present disclosure offers ways to turn carbon dioxide (CO₂) into eco-friendly construction materials by integrating CO₂ mineralization and concrete 3D printing technology.

2. The new, thermo-responsive, rapid stiffening 3D printable suspension formulations facilitate an optimized balance between flowability and buildability, enabling greater overhangs, increased print heights, faster production rates, and enhanced print fidelity in extrusion-based 3D printing.

3. Concentrated cementitious suspensions are engineered to exhibit thermal latency, a tunable induction period, and rapid stiffening through the utilization of thermally triggered radical polymerization reactions involving the monomers incorporated within the suspensions. These reactions enable a controlled and ultrafast stiffening of highly concentrated suspensions at temperatures below 80 °C, ensuring robust performance during 3D printing processes.

4. The thermo-responsive suspension formulation comprises carefully selected monomers, crosslinking agents reactive therewith, initiators, water, appropriate dispersants, and a large volume fraction of solid binders such as, but not limited to, portlandite and fly ash (inorganic fillers). The solid binders constitute the inorganic fillers in the formulation and may include a mixture of various mineral particles such as cement, slag, silica fume, quartz, limestone, and other combinations, with a primary focus on Portlandite-fly ash mixtures.

5. Adjustments to suspension formulation and processing parameters can be made to attain the desired thermal responsiveness and stiffening kinetics, tailored to meet the specific requirements of the 3D printing process and/or the geometric characteristics of the structure to be printed.

6. The thermo-responsive suspension formulation produces ultrafast stiffening irrespective of the pH of the suspending medium. The thermo-responsive suspension formulation is capable of achieving ultra-fast stiffening, regardless of the pH of the suspending medium, ensuring reliable performance across diverse binder mixtures.

7. The post-curing of printed structures in an optimized CO₂-rich environment facilitates Portlandite carbonation and the pozzolanic reaction of the solid binders listed above (e.g., mixtures of various mineral particles such as cement, slag, silica fume, quartz, limestone, and other combinations, including Portlandite-fly ash mixtures), resulting in composites with sufficient compressive strength of approximately 30 MPa, meeting the performance standards for construction applications, including internal floor slabs, large walls, garages, and residential buildings or extensions.

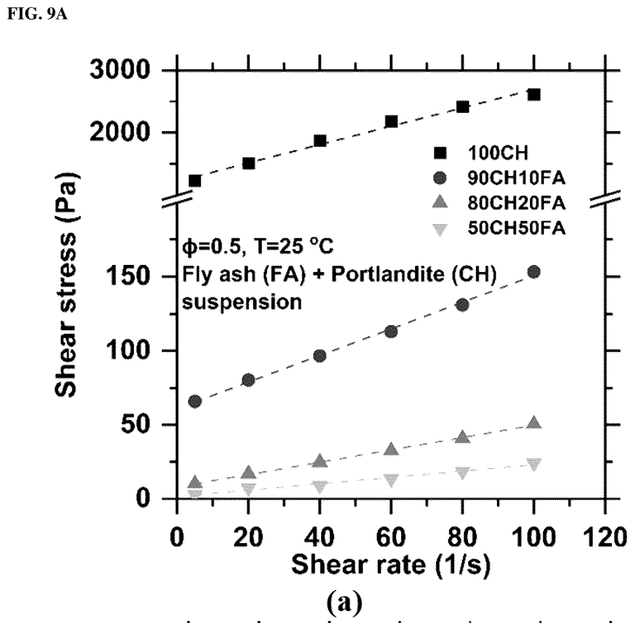

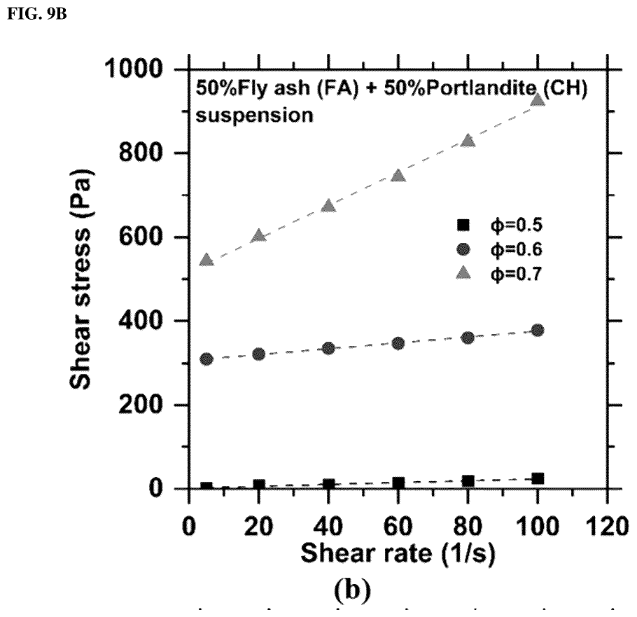

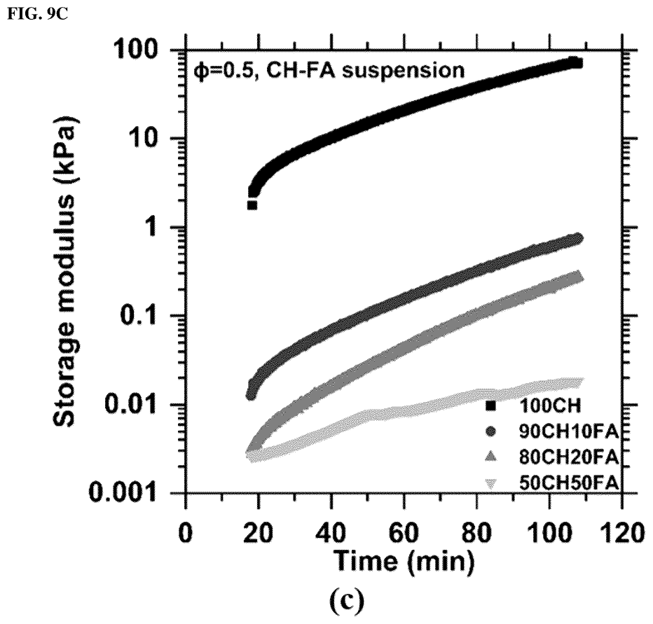

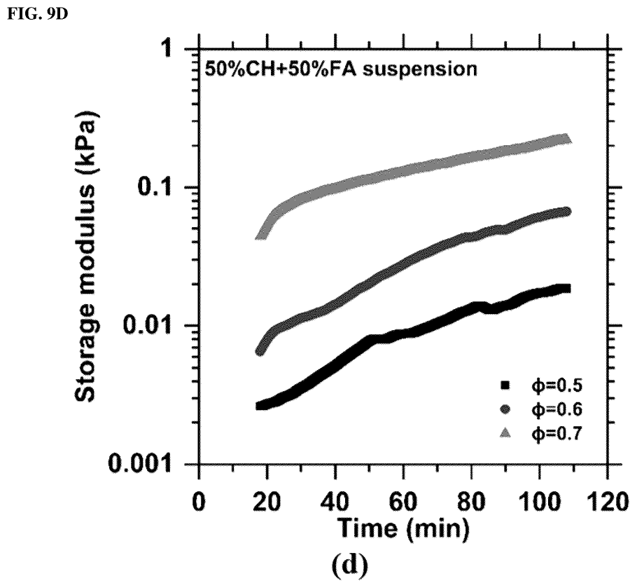

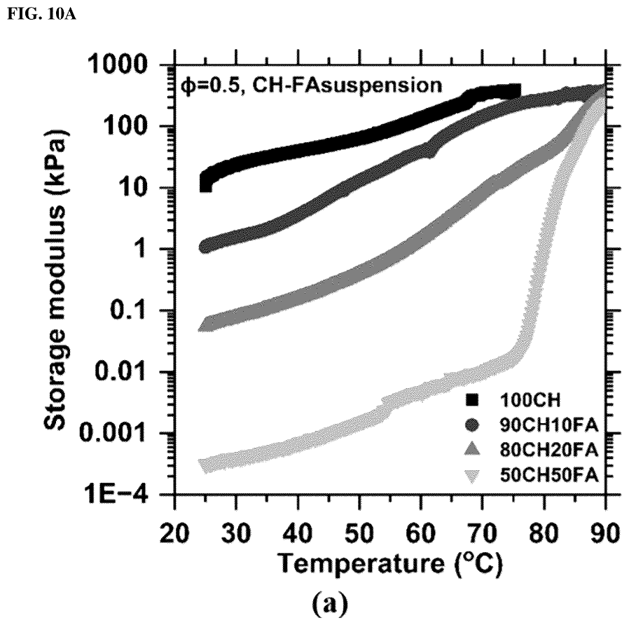

8. Optimal fly ash content ranging from 0 to 50 wt. % of the total solid and a solid volume fraction (φ) between 0.5 and 0.7 are utilized to achieve the desired flowability and adequate open time for the pumping stage. (FIG. 9)

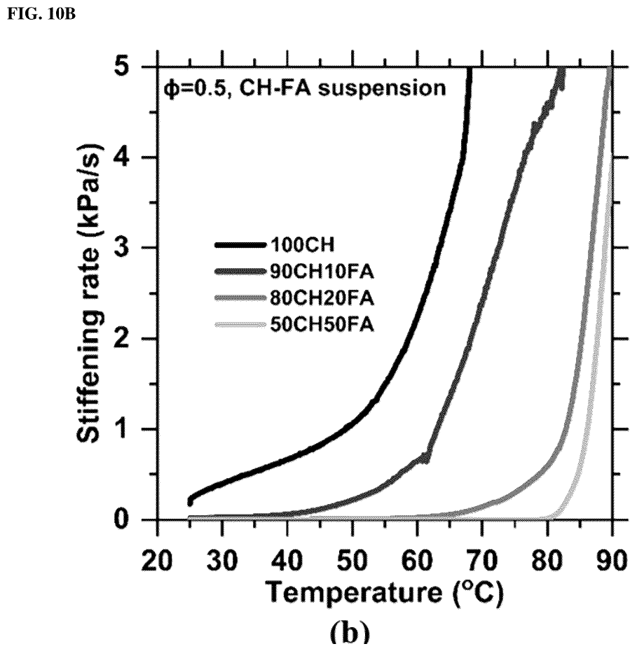

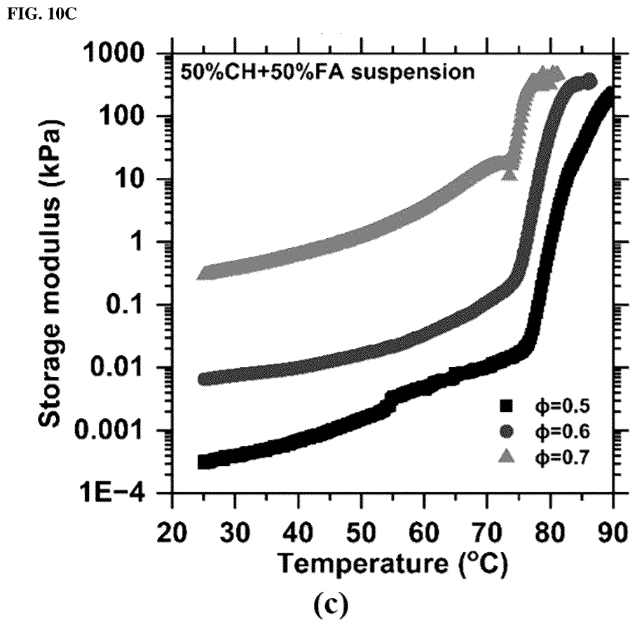

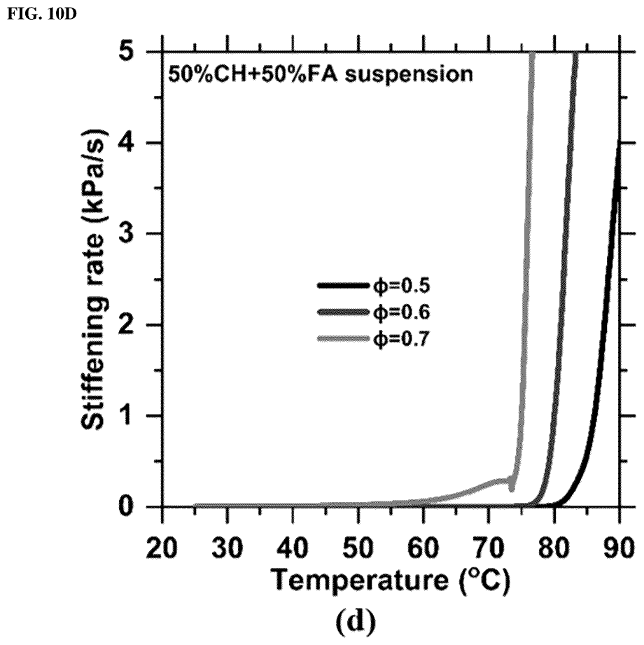

9. Rapid stiffening concentrated suspensions feature a fly ash content in the range of 0-50%, and a solid content in the range of 0.5-0.7. These suspension formulations can induce rapid solidification to a 2-3 MPa level strength within an activation timeframe of 30 to 200 seconds under bulk thermal stimulation, resulting in stiffening rates ranging from 0.5 KPa/s to 2.6 KPa/s. (FIG. 10)

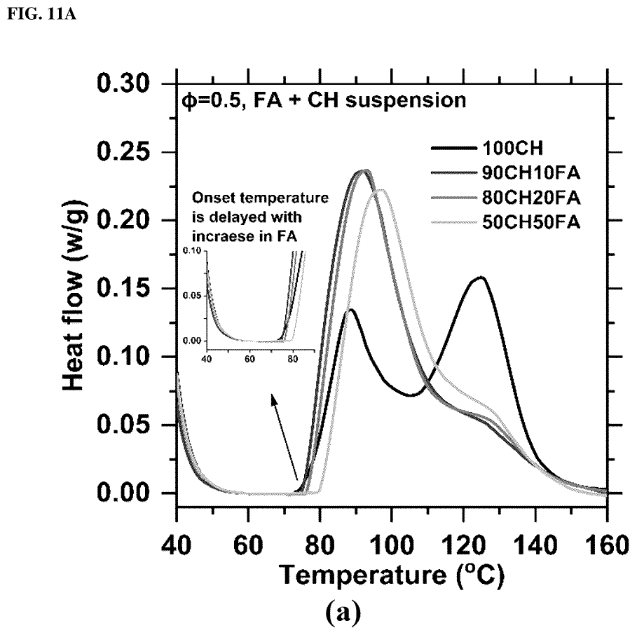

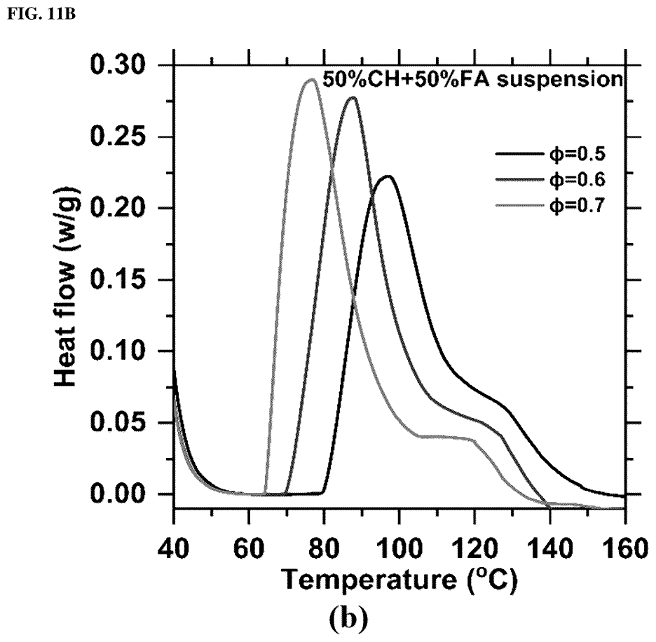

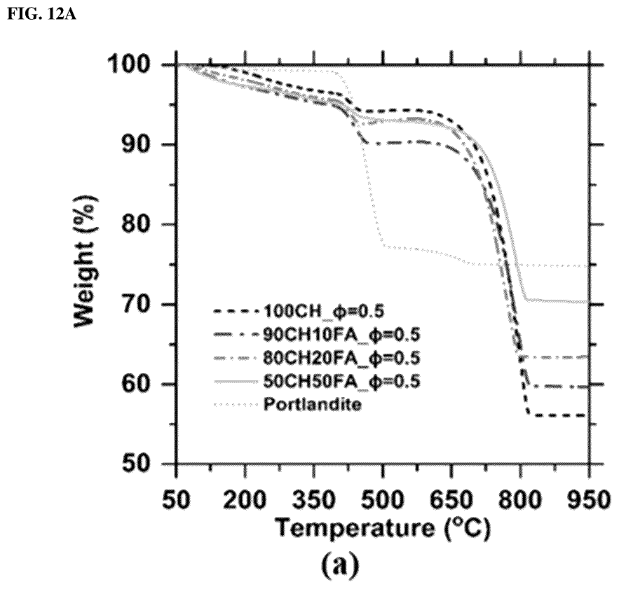

10. The thermo-responsive suspension formulations with fly ash exhibit controllable reaction rates at trigger temperatures ranging between 70 °C and 80 °C, where the trigger temperature is influenced by the fly ash content and the solid volume fraction in the formulation. (FIG. 11)

11. Suspensions containing 50% fly ash exhibit superior pumpability, a thermal latency up to 75 °C, and an induction period of up to 2 hours at ambient temperature (25 °C).

12. Post-curing of the printed components at optimal conditions (temperatures ranging between 50 °C to 90 °C, relative humidity between 50%-95%, CO₂ concentrations of 2%-14%, (v/v), and curing durations of 1 d to 7 days) ensures the complete polymerization of the thermo-responsive monomers dispersed in the suspension, carbonation of portlandite, and the pozzolanic reaction of fly ash, thereby enhancing the strength of the hybrid composite.

13. With the addition of fly ash, these suspensions exhibit an increased compressive strength from 5 MPa to 30 MPa within 7 days, and CO₂ uptake in the range of 0.3 to 0.6 g CO₂/g Portlandite. (FIG. 12)

14. A continuous dynamic mixing system is utilized to consistently prepare the suspension from its constituent materials, which is then delivered to the extrusion system through pumping. The process incorporates heating through either a single-stage or two-stage method using a suitable heating element during extrusion. The first heating stage raises the temperature to a threshold level at the auger, followed by a second heating stage at the nozzle (FIG. 13). Alternatively, the suspension can be heated immediately upon exiting the nozzle or during deposition The heating rates are adjusted to meet specific overhang requirements and achieve the targeted early-age strength of the printed elements.

In certain aspects, provided herein is a method of producing a 3D-printed concrete product, comprising:
preparing a thermo-responsive suspension comprising a binder and an alkaline solution;
extruding the thermo-responsive suspension under controlled heating, thereby producing a 3D-printed structural component; and
curing the 3D-printed structural component, thereby producing a 3D-printed concrete product.

In certain embodiments, the suspension further comprises a thermo-responsive additive. In certain such embodiments, the thermo-responsive additive is selected from monomers, crosslinking agents, initiators, water, dispersants, and any combination thereof. In further embodiments, the thermo-responsive additive is selected from acrylamide, trimethylolpropane trimethacrylate, 2,2′-Azobis[2-(2-imidazolin-2-yl) propane]dihydrochloride, polycarboxylate ether-based dispersant, and any combination thereof.

In certain embodiments, the binder comprises portlandite, fly ash, cement, slag, silica fume, quartz, limestone, calcined clay, recycled concrete, or any combination thereof. In certain such embodiments, the binder comprises fly ash and portlandite. In further embodiments, the fly ash and portlandite comprise oxides. In certain such embodiments, the fly ash and portlandite comprise CaO, SiO₂, Al₂O₃, MgO, SO₃, TiO₂, K₂O, Na₂O, FeO, or any combination thereof. In further embodiments, the fly ash is alkali-activated fly ash.

In certain embodiments, the binder comprises about 10% portlandite and about 90% fly ash by mass. In further embodiments, the binder comprises about 20% portlandite and about 80% fly ash by mass. In yet further embodiments, the binder comprises about 30% portlandite and about 70% fly ash by mass. In still further embodiments, the binder comprises about 40% portlandite and about 60% fly ash by mass. In certain embodiments, the binder comprises about 50% portlandite and about 50% fly ash by mass. In further embodiments, the binder comprises about 60% portlandite and about 40% fly ash by mass. In yet further embodiments, the binder comprises about 70% portlandite and about 30% fly ash by mass. In still further embodiments, the binder comprises about 80% portlandite and about 20% fly ash by mass. In certain embodiments, the binder comprises about 90% portlandite and about 10% fly ash by mass.

In certain embodiments, the alkaline solution concentration is from about 4 molar to about 12 molar. In further embodiments, the alkaline solution concentration is about 4 molar. In yet further embodiments, the alkaline solution concentration is about 5 molar. In still further embodiments, the alkaline solution concentration is about 6 molar. In certain embodiments, the alkaline solution concentration is about 7 molar. In further embodiments, the alkaline solution concentration is about 8 molar. In yet further embodiments, the alkaline solution concentration is about 9 molar. In still further embodiments, the alkaline solution concentration is about 10 molar. In certain embodiments, the alkaline solution concentration is about 11 molar. In further embodiments, the alkaline solution concentration is about 12 molar.

In certain embodiments, the alkaline solution and the binder in the thermo-responsive suspension have a mass ratio from about 0.2 to about 1. In further embodiments, the mass ratio is from about 0.3 to about 0.6. In yet further embodiments, the mass ratio is from about 0.36 to about 0.44. In certain embodiments, the mass ratio is about 0.36. In further embodiments, the mass ratio is about 0.37. In yet further embodiments, the mass ratio is about 0.38. In still further embodiments, the mass ratio is about 0.39. In certain embodiments, the mass ratio is about 0.40. In further embodiments, the mass ratio is about 0.41. In yet further embodiments, the mass ratio is about 0.42. In still further embodiments, the mass ratio is about 0.43. In certain embodiments, the mass ratio is about 0.44.

In certain embodiments, the 3D-printed structural component is cured at a temperature of from about 50 °C to about 90 °C. In certain such embodiments, the 3D-printed structural component is cured at a temperature of from about 70 °C to about 85 °C. In certain embodiments, the 3D-printed structural component is cured at a temperature of about 70 °C. In further such embodiments, the 3D-printed structural component is cured at a temperature of about 75 °C. In yet further embodiments, the 3D-printed structural component is cured at a temperature of about 80 °C. In still further embodiments, the 3D-printed structural component is cured at a temperature of about 85 °C.

In certain embodiments, the 3D-printed structural component is cured at a relative humidity of from about 50% to about 95%. In certain such embodiments, the 3D-printed structural component is cured at a relative humidity of from about 60% to about 75%. In certain embodiments, the 3D-printed structural component is cured at a relative humidity of about 60%. In further embodiments, the 3D-printed structural component is cured at a relative humidity of about 65%. In yet further embodiments, the 3D-printed structural component is cured at a relative humidity of about 70%. In still further embodiments, the 3D-printed structural component is cured at a relative humidity of about 75%.

In certain embodiments, the 3D-printed structural component is cured at a CO₂ concentration of from about 2% to about 14% (v/v). In certain such embodiments, the 3D-printed structural component is cured at a CO₂ concentration of from about 8% to about 14% (v/v). In certain embodiments, the 3D-printed structural component is cured at a CO₂ concentration of about 8% (v/v). In further embodiments, the 3D-printed structural component is cured at a CO₂ concentration of about 9% (v/v). In yet further embodiments, the 3D-printed structural component is cured at a CO₂ concentration of about 10% (v/v). In still further embodiments, the 3D-printed structural component is cured at a CO₂ concentration of about 11% (v/v). In certain embodiments, the 3D-printed structural component is cured at a CO₂ concentration of about 12% (v/v). In further embodiments, the 3D-printed structural component is cured at a CO₂ concentration of about 13% (v/v). In yet further embodiments, the 3D-printed structural component is cured at a CO₂ concentration of about 14% (v/v).

In certain embodiments, the 3D-printed structural component is cured for about 1 day to about 7 days. In certain such embodiments, the 3D-printed structural component is cured for about 1 day. In further embodiments, the 3D-printed structural component is cured for about 2 days. In yet further embodiments, the 3D-printed structural component is cured for about 3 days. In still further embodiments, the 3D-printed structural component is cured for about 4 days. In certain embodiments, the 3D-printed structural component is cured for about 5 days. In further embodiments, the 3D-printed structural component is cured for about 6 days. In yet further embodiments, the 3D-printed structural component is cured for about 7 days.

In certain embodiments, the binder is prepared by dry mixing portlandite and fly ash.

In certain embodiments, controlled heating comprises a rate from about 1 to about 10 °C/minute. In certain such embodiments, controlled heating comprises a rate of about 1 °C/minute. In further embodiments, controlled heating comprises a rate of about 2 °C/minute. In yet further embodiments, controlled heating comprises a rate of about 3 °C/minute. In still further embodiments, controlled heating comprises a rate of about 4 °C/minute. In certain embodiments, controlled heating comprises a rate of about 5 °C/minute. In further embodiments, controlled heating comprises a rate of about 6 °C/minute. In yet further embodiments, controlled heating comprises a rate of about 7 °C/minute. In still further embodiments, controlled heating comprises a rate of about 8 °C/minute. In certain embodiments, controlled heating comprises a rate of about 9 °C/minute. In further embodiments, controlled heating comprises a rate of about 10 °C/minute.

In certain embodiments, the controlled heating stops at a temperature between about 70 °C to about 80 °C. In certain such embodiments, the controlled heating stops at about 70 °C. In further embodiments, the controlled heating stops at about 71 °C. In yet further embodiments, the controlled heating stops at about 72 °C. In still further embodiments, the controlled heating stops at about 73 °C. In certain embodiments, the controlled heating stops at about 74 °C. In further embodiments, the controlled heating stops at about 75 °C. In yet further embodiments, the controlled heating stops at about 76 °C. In still further embodiments, the controlled heating stops at about 77 °C. In certain embodiments, the controlled heating stops at about 78 °C. In further embodiments, the controlled heating stops at about 79 °C. In yet further embodiments, the controlled heating stops at about 80 °C.

In certain embodiments, the method is a continuous method.

In certain aspects, provided herein is a thermo-responsive suspension comprising
a binder; and
an alkaline solution at alkaline solution concentration,
wherein the alkaline solution and the binder in the thermos-responsive suspension have a mass ratio from about 0.2 to about 1; and
wherein the alkaline solution concentration is between about 4 molar to about 12 molar.

In certain embodiments, the thermo-responsive suspension further comprises a thermo-responsive additive. In certain such embodiments, the thermo-responsive additive is selected from monomers, crosslinking agents, initiators, water, dispersants, and any combination thereof. In further embodiments, the thermo-responsive additive is selected from acrylamide, trimethylolpropane trimethacrylate, 2,2′-Azobis[2-(2-imidazolin-2-yl) propane]dihydrochloride, polycarboxylate ether-based dispersant and any combination thereof.

In certain embodiments, the binder comprises portlandite, fly ash, cement, slag, silica fume, quartz, limestone, slag, fly ash, silica fume, or any combination thereof. In certain such embodiments, the binder comprises fly ash and portlandite. In further embodiments, the fly ash and portlandite comprise oxides. In certain such embodiments, the fly ash and portlandite comprise CaO, SiO₂, Al₂O₃, MgO, SO₃, TiO₂, K₂O, Na₂O, FeO, or any combination thereof. In certain embodiments, the fly ash is alkali-activated fly ash.

In certain embodiments, the suspension comprises about 10% portlandite and about 90% fly ash by mass. In further embodiments, the suspension comprises about 20% portlandite and about 80% fly ash by mass. In yet further embodiments, the suspension comprises about 30% portlandite and about 70% fly ash by mass. In still further embodiments, the suspension comprises about 40% portlandite and about 60% fly ash by mass. In certain embodiments, the suspension comprises about 50% portlandite and about 50% fly ash by mass. In further embodiments, the suspension comprises about 60% portlandite and about 40% fly ash by mass. In yet further embodiments, the suspension comprises about 70% portlandite and about 30% fly ash by mass. In still further embodiments, the suspension comprises about 80% portlandite and about 20% fly ash by mass. In certain embodiments, the suspension comprises about 90% portlandite and about 10% fly ash by mass.

In certain embodiments, the alkaline solution is sodium hydroxide.

In certain embodiments, the alkaline solution concentration is about 4 molar. In further embodiments, the alkaline solution concentration is about 5 molar. In yet further embodiments, the alkaline solution concentration is about 6 molar. In still further embodiments, the alkaline solution concentration is about 7 molar. In certain embodiments, the alkaline solution concentration is about 8 molar. In further embodiments, the alkaline solution concentration is about 9 molar. In yet further embodiments, the alkaline solution concentration is about 10 molar. In still further embodiments, the alkaline solution concentration is about 11 molar. In certain embodiments, the alkaline solution concentration is about 12 molar.

In certain embodiments, the mass ratio is from about 0.3 to about 0.5. In further embodiments, the mass ratio is from about 0.36 to about 0.44. In yet further embodiments, the mass ratio is about 0.36. In still further embodiments, the mass ratio is about 0.37. In certain embodiments, the mass ratio is about 0.38. In further embodiments, the mass ratio is about 0.39. In yet further embodiments, the mass ratio is about 0.40. In still further embodiments, the mass ratio is about 0.41. In certain embodiments, the mass ratio is about 0.42. In further embodiments, the mass ratio is about 0.43. In yet further embodiments, the mass ratio is about 0.44.

In certain embodiments, the thermo-responsive formulation is a slurry.

In certain embodiments, the formulation is free of cement. In further embodiments, the formulation is essentially free of cement.

In certain aspects, provided herein is a 3D-printing system comprising:
a cementitious suspension feed;
an auger body;
a motor;
an extruder;
one or more heating elements; and
a nozzle head comprising a nozzle.

In certain embodiments, the 3D-printing system further comprises a continuous mixing system, wherein the continuous mixing system is coupled to the cementitious suspension feed.

In certain embodiments, the one or more heating elements is a single heating element. In further embodiments, the one or more heating elements comprises a first heating element and a second heating element.

In certain embodiments, the first heating element is coupled to the auger body.

In certain embodiments, the second heating element is coupled to the nozzle.

In certain embodiments, the nozzle head is detachable.

In certain embodiments, cementitious suspension feed comprises the thermo-responsive suspension of the present disclosure.

In certain aspects, provided herein is a 3D-printed concrete product produced using the method of the present disclosure, having a compressive strength from about 5 MPa to about 30 MPa. In certain such aspects, provided herein is a 3D-printed concrete product produced using the method of the present disclosure, having a compressive strength of about 5 MPa. In further aspects, provided herein is a 3D-printed concrete product produced using the method of the present disclosure, having a compressive strength of about 10 MPa. In yet further aspects, provided herein is a 3D-printed concrete product produced using the method of the present disclosure, having a compressive strength of about 15 MPa. In still further aspects, provided herein is a 3D-printed concrete product produced using the method of the present disclosure, having a compressive strength of about 20 MPa. In certain aspects, provided herein is a 3D-printed concrete product produced using the method of the present disclosure, having a compressive strength of about 25 MPa. In further aspects, provided herein is a 3D-printed concrete product produced using the method of the present disclosure, having a compressive strength of about 30 MPa.

### Examples

The present invention provides the use of CH as an optimal additive for FA activation in thermo-responsive formulations that overcome issues related to balancing buildability and printability. While not bound by theory, it is believed that incorporating CH into AAF blends may simultaneously improve the stiffening rate and alkaline reaction under temperature stimulation, facilitating active rheology control during the printing process. It is reported that the viscosity of concentrated suspensions containing CH increases as the temperature increases. This behavior is characterized by an unconventional “negative” effective activation energy concerning viscous flow. The elevation in temperature is observed to attenuate electrostatic repulsion forces, consequently accelerating particle aggregation and the consequent development of larger aggregates. These alterations may collectively give rise to the atypical rheological behavior observed in these CH suspensions. Meanwhile, the pozzolanic reaction between FA and CH can be enhanced with temperature increase. These distinctive attributes of CH may enhance printability and mechanical performance at later stages. The approach creates a pathway for composing cement clinker-free formulations for 3D-printing applications.

### Materials and Methods

### Materials

The binders consist of Class F fly ash (FA) sourced from the combustion of pulverized coal, and Portlandite (Ca(OH)₂, CH) with a purity of 95%, obtained from Standard Hydrated Lime and Mississippi Lime Company, respectively. Table 1 presents their oxide compositions as analyzed using X-ray fluorescence (Hitachi Model X-Supreme8000 1). Their particle size distributions were measured using static light scattering (SLS; Partica LA-960A2, Horiba) on dilute suspensions of particles dispersed in isopropanol. The median particle diameter d50 of CH and FA was 5.7 μm±0.1 μm and 39.2 μm±0.1 μm. To enhance the pozzolanic reaction of FA, sodium hydroxide (caustic soda, NaOH) was used to prepare the pastes. The sodium hydroxide solutions were prepared by mixing deionized water with sodium hydroxide pellets to achieve the molarities of 4 M, 8 M, 10 M, and 12 M. These solutions were prepared 24 h prior to use to ensure full dissolution and were carefully sealed using a plastic film to prevent carbonation.

### Mixture Design and Sample Preparation

The effect of varying CH addition, NaOH concentration, and solution to binder mass ratio (s/b, unitless) on the rheology and stiffening rate was systematically evaluated. The mixture design is shown in Table 2. To improve thermo-responsive stiffening and enhance the alkaline reaction of FA, CH particles were incorporated into the FA mixture at varying replacement rates of 0%, 10%, 20%, 30%, and 50% by mass. Another key factor in controlling the alkaline reaction of FA is the NaOH concentration, which was varied between 0 mol/L to 12 mol/L. To assess the rheological properties of the mixtures, the s/b value was varied from 0.36 to 0.44. To prepare the suspensions, CH and FA particles were combined by dry mixing in a Hobart mixing bowl for 10 min. Subsequently, the alkaline solution was introduced into the mixing bowl. The mixture was subjected to high shear mixing for an additional 3 min.

### Rheology, Stiffening Process, and Mechanical Performance

The rheology of the suspensions was characterized by using a rotational rheometer (Discovery HR-2, TA Instruments). A vane-in-cup geometry with a four-bladed vane was used, with a vane of 28 mm diameter and 42 mm height, and a cup of 30 mm diameter. A ceramic lid was used on the cup to mitigate water evaporation. The rheometer was equipped with a Peltier concentric jacket to control temperature. The flow curves and time-sweep small amplitude oscillatory shear (SAOS) tests were performed at 25 °C to evaluate the flow characteristics and structural build-up, respectively. Herein, the increase of the elastic modulus, denoted as G′, at ambient temperature was used to assess the open time in the context of 3D printing. The flow curve protocol consists of three stages: the first stage is the pre-shear at 100 s⁻¹ for 30 s, followed by a resting period for another 30 s to eliminate residual stresses. Subsequently, the protocol enters its second phase, characterized by incrementally stepped shear rate increments from 5 s⁻¹ to 100 s⁻¹, with each step lasting 20 s. The third phase consists of a decremental stepwise reduction of the shear rate from 100 s⁻¹ to 5 s⁻¹, again with each step taking 20 s, which is also used for Bingham model fitting to determine the yield stress and plastic viscosity. The time-sweep tests were conducted at a constant frequency of 1 Hz and an oscillation strain of 0.05%. The stiffening of the suspensions was tracked by the temperature-dependent evolution of G′. The suspensions underwent an oscillatory temperature ramp with a constant frequency of 1 Hz and a strain amplitude of 0.05%, with a controlled temperature increment from 25 °C±0.1 °C-90 °C±0.1 °C. The suspension was subjected to a temperature ramp at a rate of 2 °C/min to ensure uniform temperature distribution and minimize thermal lag. It should be noted that prior to SAOS tests, all suspensions underwent a pre-shear and resting period to generate a homogeneous suspension and remove shear history effects. The mechanical strength of each CH-FA mixture (cast specimen, which could have different strength from the 3D-printed sample) was evaluated in compression, which was performed on 30 mm×30 mm×30 mm cubic specimens using a CM-3000 Compression Testing Apparatus. At temperatures exceeding 65 °C, the dissolution of FA and the precipitation of hydration products may be enhanced. The specimens were sealed with plastic film and cured in a temperature-controlled room at temperature of 65 °C until the testing age of 1 d, 2 d and 7 d (The free water within the samples was retained sealing the samples with a plastic film, preventing evaporation), and then subjected to loading at a compression rate of 1 kN/s. The average compressive strength and uncertainty were determined by repeating the test for six samples.

TABLE 1
The oxide compositions of the fly ash and Portlandite used.

| Oxide (mass %) | CaO | SiO₂ | [symbol] | MgO | [symbol] | [symbol] | [symbol] | [symbol] | [symbol] |
|---|---|---|---|---|---|---|---|---|---|
| Fly ash (FA) | [symbol] | 50.39 | 25.34 | 1.11 | [symbol] | [symbol] | 2.02 | 0.59 | [symbol] |
| Portlandite (CH) | 95.97 | [symbol] | 0.73 | 0.60 | 0.07 | — | 0.06 | — | — |

[symbol]

indicates data missing or illegible when filed

TABLE 2
The mixture design of CH-FA pastes.

| | CH | | NaOH | Solution to |
|---|---|---|---|---|
| Mixture | amount | FA amount | concentration | binder ratio |
| notation | (mass %) | (mass %) | (mol/L) | (s/b) |
| 100FA | 0 | 100 | 8M | 0.44 |
| 10CH90FA | 10 | 90 | 8M | 0.44 |
| 20CH80FA | 20 | 80 | 8M | 0.44 |
| 30CH70FA | 30 | 70 | 8M | 0.44 |
| 50CH50FA | 50 | 50 | 8M | 0.44 |
| 20CH80FA_0M | 20 | 80 | 0M | 0.44 |
| 20CH80FA_4M | 20 | 80 | 4M | 0.44 |
| 20CH80FA_10M | 20 | 80 | 10M | 0.44 |
| 20CH80FA_12M | 20 | 80 | 12M | 0.44 |
| 20CH80FA_0.40 | 20 | 80 | 8M | 0.40 |
| 20CH80FA_0.36 | 20 | 80 | 8M | 0.36 |

### Reaction Kinetics and Microstructural Analysis

Reaction kinetics by isothermal calorimetry and differential scanning calorimetry: The reaction kinetics of the mixtures was evaluated using isothermal calorimetry. To be consistent with the compressive strength tests, the calorimetric measurements were carried out at 65±0.02 °C over a period of 7 d. After mixing, the paste was immediately transferred to a glass ampoule and then placed into the calorimeter. The reaction kinetics of during the temperature ramp were evaluated using differential scanning calorimetry (DSC25, TA Instruments). Approximately 20 mg of the suspension were placed within a high-pressure capsule and exposed to a controlled heating rate of 2 °C/min, within the temperature range of 35 °C-200 °C, under an inert nitrogen atmosphere. The heat flux was assessed during the temperature ramp and compared with results of small amplitude oscillation shear tests during temperature ramping. Reaction products by thermogravimetric analysis and X-ray diffraction (XRD): A PerkinElmer STA 6000 thermogravimetric analyzer (TGA) was used to identify the reaction products formed. The hardened samples (following strength testing) were finely powdered. During thermal analysis, the powder sample was equilibrated at 35 °C for 5 min before being heated at a rate of 15 °C/min from 35 °C to 1000 °C. Mass loss, as determined by thermogravimetry (TG) and its derivative (DTG), were used to characterize and quantify the reaction products calcium aluminosilicate hydrate/sodium aluminosilicate hydrate (C-(A-)S—H/N-A-S—H), calcium hydroxide (CH), and calcium carbonate (CaCO₃). CH and CaCO₃ contents were quantified using a tangent method in the temperature ranges of approximately 400 °C-520 °C and 600 °C-900 °C, respectively. Similarly, X-ray diffraction (XRD) analyses were performed on the powdered samples using a PANalytical X'PertPro diffractometer employing Cu-Kα radiation (λ=1.54 Å) in a θ-θ configuration using an X'Celerator 2 detector. Scans were conducted by rotating the sample stage over the range 5°-70° range with a 0.02° step size. Rietveld refinement was conducted using Profex to ascertain the precise quantities of identified crystalline phases. ZnO constituting 10 mass % of the sample mass was added as an internal standard. Pore solution chemistry by Inductively Coupled Plasma Optical Emission Spectroscopy (ICP-OES): An assessment of the pore solution chemistry in selected suspensions was conducted to elucidate the reaction kinetics during the curing of alkali-activated CH-FA suspensions. The freshly prepared suspension was cured for 15 min at different temperatures ranging from 25 °C to 90 °C. The suspension was separated via a centrifuge operating at 5000 rpm for 10 min and the supernatant was collected using a 0.45 μm syringe filter. The solution was then diluted by a (mass) factor of 1400 using 5% (v/v) nitric acid (0.79 mmol/L HNO3) and subjected to ICP-OES analysis. This analysis enabled the quantification of Silicon (Si), Aluminum (Al), Sodium (Na), and Calcium (Ca) concentrations in the pore solution.

### Thermodynamic Modeling

The concentrations of various ions in the pore solution were used to determine effective saturation indices (ESI, unitless) for various solids, facilitating an assessment of their potential for precipitation. The ESI for a given solid is expressed as log (IAP/KS0)/N, where IAP represents the ion activity product derived from the measured solution concentrations, KS0 is the solubility product specific to the corresponding solid, and N denotes the number of ions participating in the reactions to form the solid. A positive saturation index indicates oversaturation, suggesting the potential formation of the solid, while a negative value signifies undersaturation, indicating that the solid cannot form or will dissolve. Herein, the phase assemblage of the CH-FA mixtures cured at different temperatures was analyzed using GEMS-Selektor v.3 (Gibbs Energy Minimization Software). The thermodynamic database Cemdata18 was utilized to assess solid phase formation. Additionally, the C—N-A-S—H phase was modeled using the “CNASH” model, which takes into account the uptake of aluminum and alkali to C—S—H phases. To improve the dataset, information on zeolites that contain Na was also included. Only the highest ESIs, relevant for the end-member of the CNASH solid solution (INFCN, (CaO)·(Na₂O)_{0.3125}·(SiO₂)1.5·(H₂O)1.1875) and zeolites (Natrolite, Na₂Al₂Si₃O₁₀ 2H₂O), were presented. The activity coefficients of aqueous species were determined using the extended Debye-Huckel equation, which may only be valid for ionic strengths of 2 mol/L, which is unlikely to significantly influence the modeling outcomes.

3D-Printing Trials with the CH-FA Suspensions

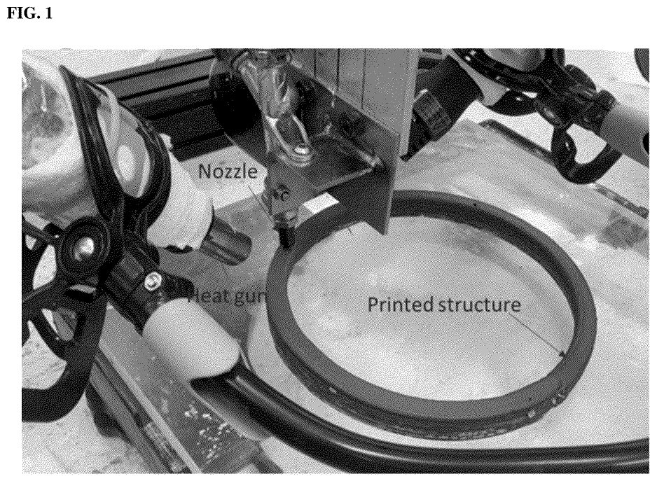

3D-printing was conducted using a custom-built 3D-printing system, as shown in FIG. 1. This system was constructed using modular extruded aluminum structural elements and was based on a gantry-based architecture. The print head was mounted on rails along the three axes (X, Y, and Z), resulting in a total print volume of 0.8 m×1.4 m×0.8 m=0.9 m³. For movement along the horizontal X and Y axes, belt-driven mechanisms with pulleys were used, while the Z-axis utilized lead screws. The diameter of the print nozzle is 6 mm. Two heat guns, each equipped with temperature and air-flow control (while our setup provides a general level of temperature control, mild fluctuations may still occur), were mounted symmetrically to ensure proper heating up on extrusion. The heat guns were positioned equidistantly on opposite sides of the print nozzle to ensure uniform heating for extrusion materials. For the printing demonstrations presented, we parametrically adjusted the temperature set point between 200±25 °C (with a maximum capability of 450 °C), while the airflow was varied between 0 and 24 liters/min (with a maximum of 120 liters/min). These settings were optimized for a printing speed of 25 mm/s to print a diversity of component geometries. Open-source Marlin firmware controlled the stepper motors, operating in 1/400 micro-steps in an open-loop configuration, utilizing DIR-PUL signals from the stepper motor drivers. The firmware was hosted on an MKS Gen_LV2.1 board featuring an ATMEL 2560 controller. The FullControl GCode Excel workbook was employed to facilitate parametric design and generate novel structures, eliminating the conventional CAD model to Slicer workflow.

### Results and Discussions

### Rheology and Stiffening Behavior of CH-FA Suspensions

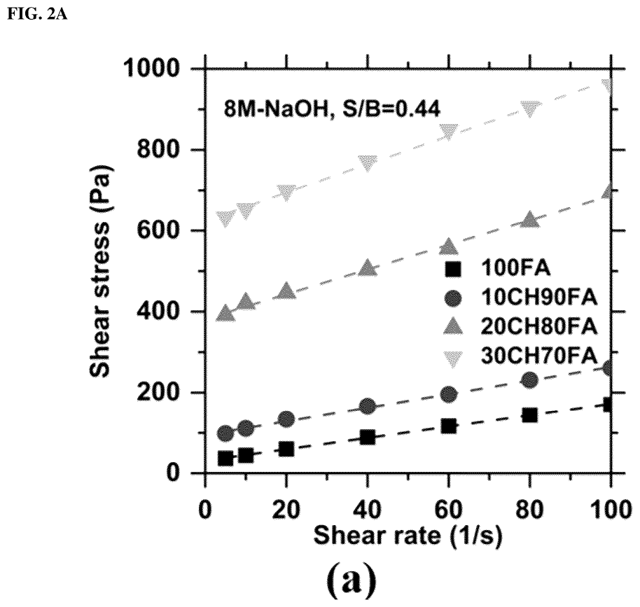

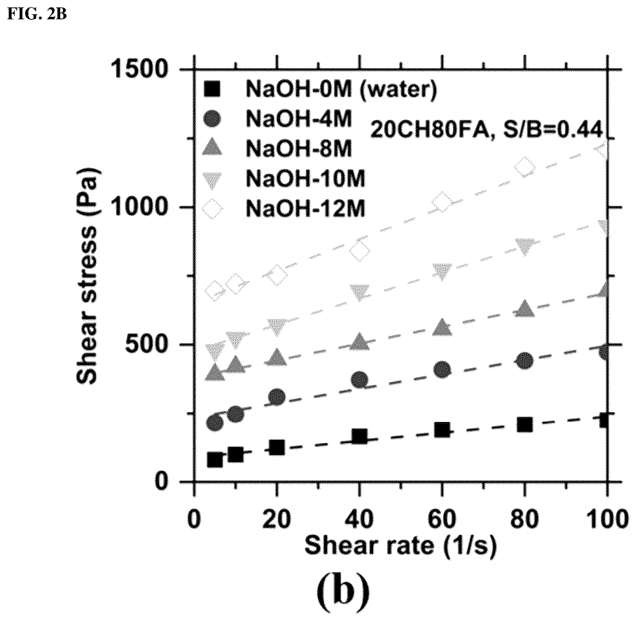

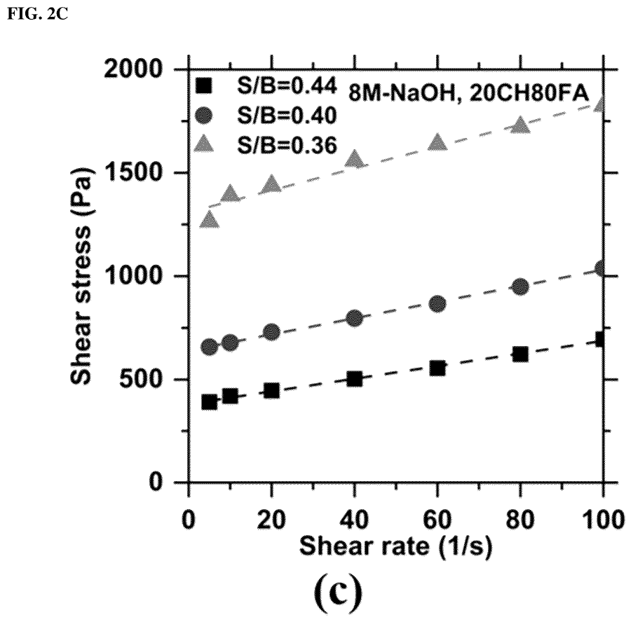

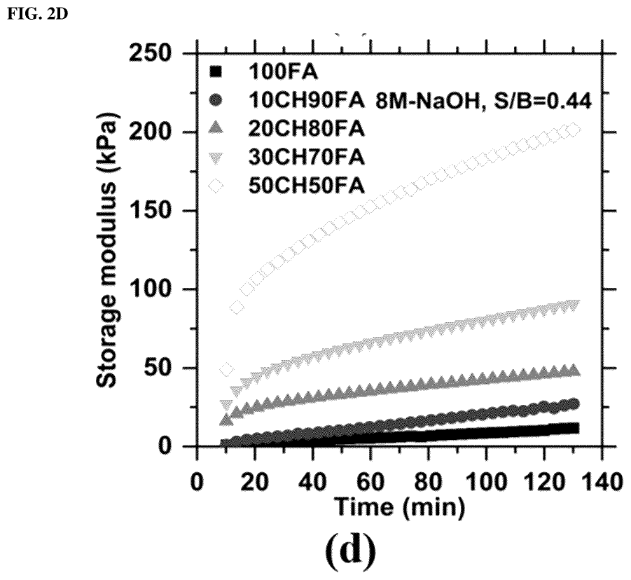

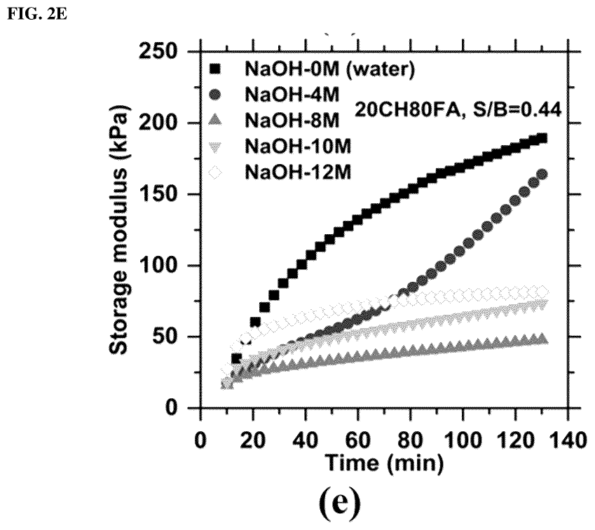

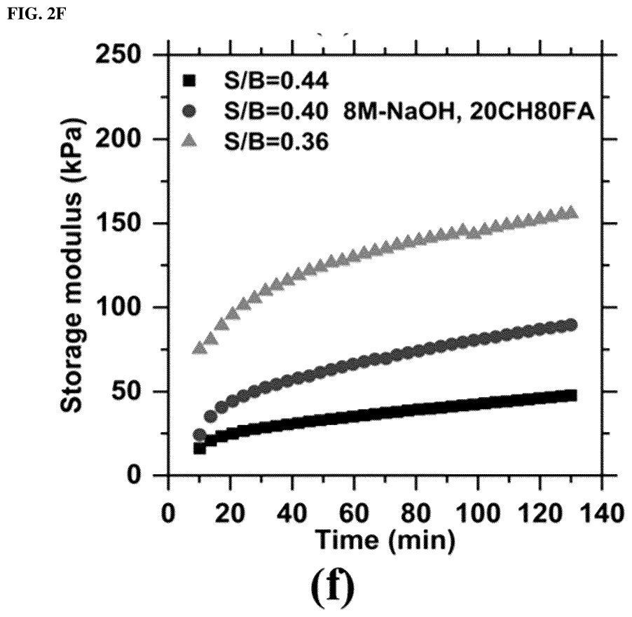

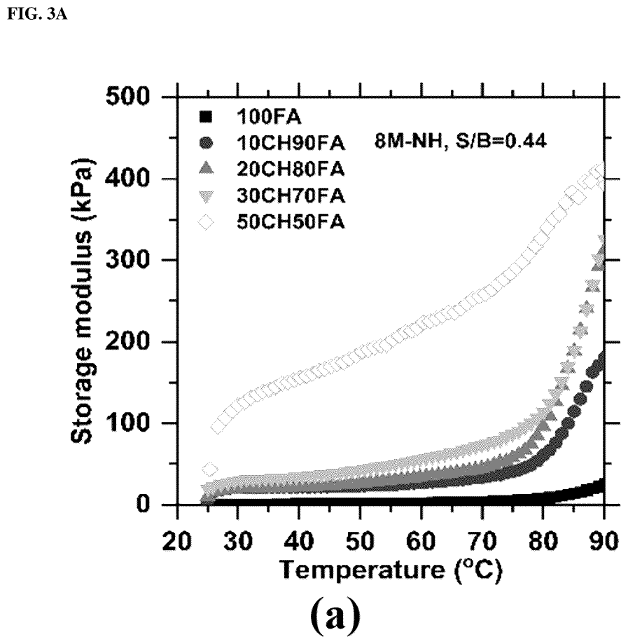

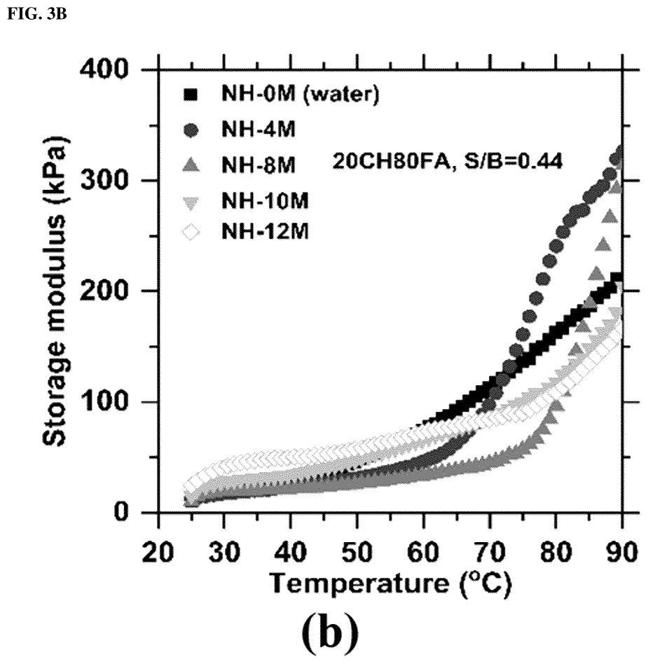

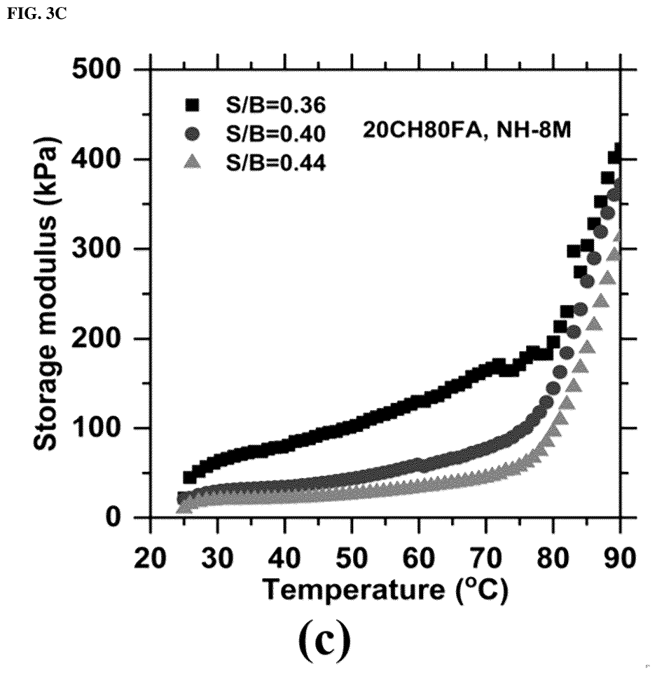

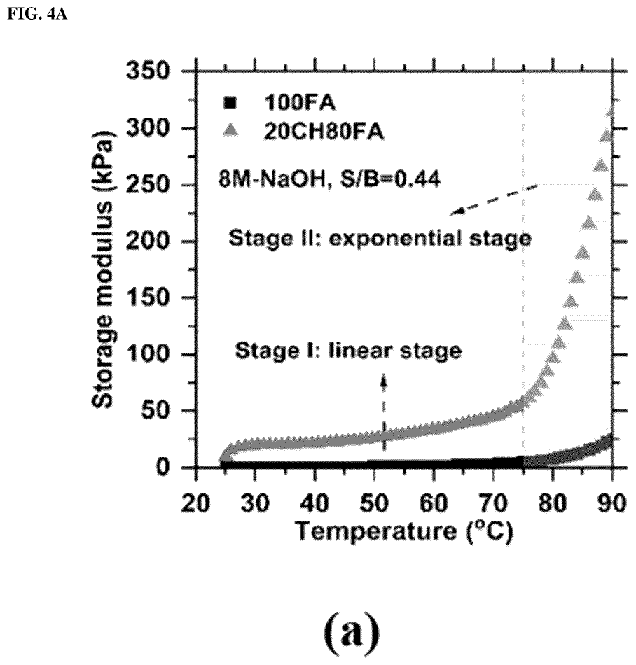

The rheology of fresh cementitious materials may dictate their 3D printing performance. FIG. 2 presents the flow curves and evolution of structural build-up at room temperature of the various CH-FA suspensions. As shown in FIG. 2 (a, b, and c), all flow curves are described adequately with the Bingham model, thereby enabling the determination of yield stress and plastic viscosity. The results of rheological parameters are summarized in Table 3. The yield stress of the CH-FA suspensions increased with increasing CH addition. The yield stress of the mixture containing only fly ash (i.e., 100FA) was the lowest, whereas the mixture containing 30% CH (i.e., 30CH70FA) exhibited a 20-fold increase in yield stress as compared to the mixture 100FA. A larger dose of CH (e.g., 50CH) resulted in a rapid loss of flowability such that the flow behavior could not be characterized with the Bingham model. The incorporation of CH increases the propensity for particle aggregation due to the high ionic strength in the solution. Typically, FA particles show a “ball-bearing” effect that reduces the yield stress. The substitution of FA with CH attenuates this effect and increases the yield stress of CH-FA suspensions. This is because the CH particles are significantly finer than the FA particles, increasing the paste's packing density and decreasing the interparticle gap, both of which enhance the suspension's resistance to shear. FIG. 2(b) exhibits the effect of NaOH concentration on the rheological behavior of CH-FA suspension (i. e., 20CH+80FA and S/B=0.44). The increased NaOH concentration increases the yield stress and plastic viscosity of the suspension. This may be attributed to the rise in the ionic strength of the suspending medium, leading to an increased propensity for particle aggregation at low levels of particle reaction. Furthermore, higher NaOH concentration increases the solution viscosity, which also increases the plastic viscosity of the paste. FIG. 2(c) shows the effect of the S/B ratio on the rheological properties (i.e., NaOH-8M, 20CH80FA). At a fixed CH and NaOH dosage, decreasing the S/B ratio increased both yield stress and plastic viscosity. This may be attributed to the closer particle packing at lower S/B that enhances direct contact between the particles, thereby elevating the yield stress and plastic viscosity. The impact of CH addition and NaOH concentration on structural build-up at room temperature (25 °C) is displayed in FIGS. 2d and e, respectively. The formulation comprising only fly ash had the lowest storage modulus, with only a slight increase detected during the first 2 h. Agglomeration caused by CH additions resulted in an increase in storage modulus with increasing CH dosage. The NaOH concentration had an intriguing effect on structure development. With increasing NaOH concentration, the initial storage modulus (at 10 min) increased. However, over longer times, the increase in NaOH concentration did not correlate with an elevated growth rate in the storage modulus (FIG. 2 (e)). In particular, formulations with a lower NaOH concentration (4M) or even those devoid of NaOH (OM) showed a fast growth in storage modulus with time, indicating increased flocculation. The observed phenomenon appears to result from the interplay between dissolution and geopolymerization processes, both of which are strongly influenced by the concentration of NaOH. Increasing NaOH concentration generally accelerates dissolution. However, previously pore solution analysis of NaOH-activated FA mixtures found that, at a low NaOH concentration (2M), the mixture presented a lower concentration of dissolved silicon (Si) and aluminum (Al) and decreased with time, indicating the geopolymerization was more dominant than dissolution. However, at a high NaOH concentration (14 M), the mixture showed elevated levels of dissolved Si and Al that continued to rise over time. This increase correlated with a significantly prolonged setting time, suggesting that dissolution was the dominant process while geo-polymerization was relatively slower. Furthermore, the storage modulus also increased with a decrease in S/B at room temperature, as shown in FIG. 2(f). The reduced S/B resulted in diminished inter-particle spacing, heightening the likelihood of agglomeration. Temperature-sweep experiments (FIG. 3) were performed for CH-FA suspension formulations with varying CH addition, NaOH content, and S/B ratio to evaluate their thermo-responsive stiffening behavior. Increased temperatures often enhance structure development, especially at temperatures above 75 °C, on account of dissolution of the fly ash and subsequent precipitation of hydration products. As such, the temperature-sweep of the suspensions reveals two distinct stages: in Stage 1, which occurred between 25 °C and 75 °C, the storage modulus increases linearly although to a limited extent, while in Stage 2, which occurred beyond 75 °C, the storage modulus exhibits rapid growth. The average stiffening rate of suspension is estimated from the second stage, as shown in Table 3. It is noted that 20% and 30% CH additions resulted in the highest stiffening rate, reaching 800 Pa/s. Furthermore, the impact of NaOH concentration on the stiffening rate aligns with the findings of the time-sweep analysis (FIG. 3(b)). It is noteworthy that elevating the NaOH concentration did not uniformly result in an increased stiffening rate within Stage 2, possibly due to the competition between dissolution and geopolymerization processes. The extent of FA dissolution may be strongly influenced by both the NaOH concentration and dissolution time. The higher NaOH concentration could lead to the dominance of dissolution kinetics over geopolymerization kinetics. NaOH concentration of 8M may induce higher FA dissolution in temperature-sweep tests, releasing sufficient Si and Al species to create optimal conditions for the geopolymerization process and achieving the highest stiffening rate. The reduction in S/B did not significantly increase the stiffening rate (see FIG. 3(c)).

TABLE 3
The rheological parameters and stiffening rates of the CH-FA suspensions.

| | | Plastic | |
|---|---|---|---|
| | Yield | viscosity | Stiffening rate |
| Mixture | stress (Pa) | (Pa · s) | (Pa/s) |
| 100FA_8M_0.44 | 31 ± 2 | 1.4 ± 0.2 | 65 ± 5 |
| 10CH90FA_8M_0.44 | 95 ± 3 | 1.7 ± 0.2 | 464 ± 12 |
| 20CH80FA_8M_0.44 | 382 ± 7 | 3.1 ± 0.2 | 806 ± 16 |
| 30CH70FA_8M_0.44 | 625 ± 9 | 3.5 ± 0.1 | 818 ± 17 |
| 50CH50FA_8M_0.44 | / | / | 202 ± 9 |
| 20CH80FA_0M_0.44 | 89 ± 4 | 1.5 ± 0.1 | 173 ± 5 |
| 20CH80FA_4M_0.44 | 235 ± 8 | 2.6 ± 0.2 | 301 ± 11 |
| 20CH80FA_10M_0.44 | 478 ± 12 | 4.7 ± 0.3 | 244 ± 10 |
| 20CH80FA_12M_0.44 | 653 ± 11 | 5.8 ± 0.2 | 198 ± 9 |
| 20CH80FA_8M_0.40 | 641 ± 5 | 3.9 ± 0.1 | 825 ± 8 |
| 20CH80FA_8M_0.36 | 1309 ± 24 | 5.3 ± 0.2 | 815 ± 26 |

### The Evolution of the Stiffening Process, Reaction Kinetics, Pore Solution Chemistry, and Effective Saturation Index of CH-FA Suspensions at Early Stages

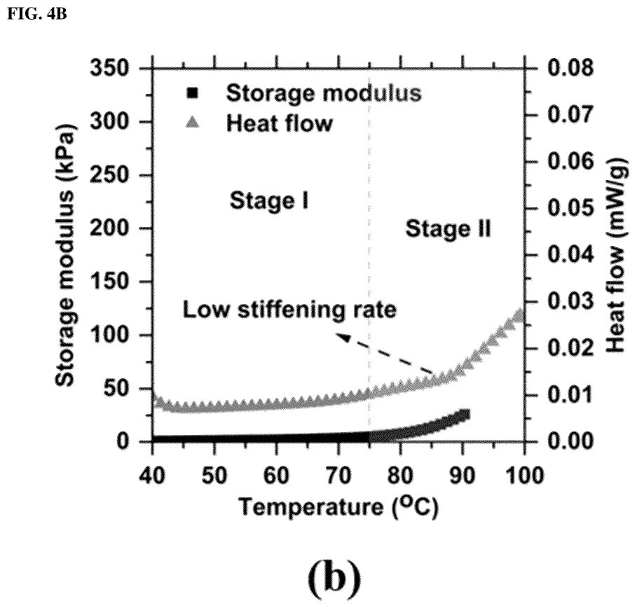

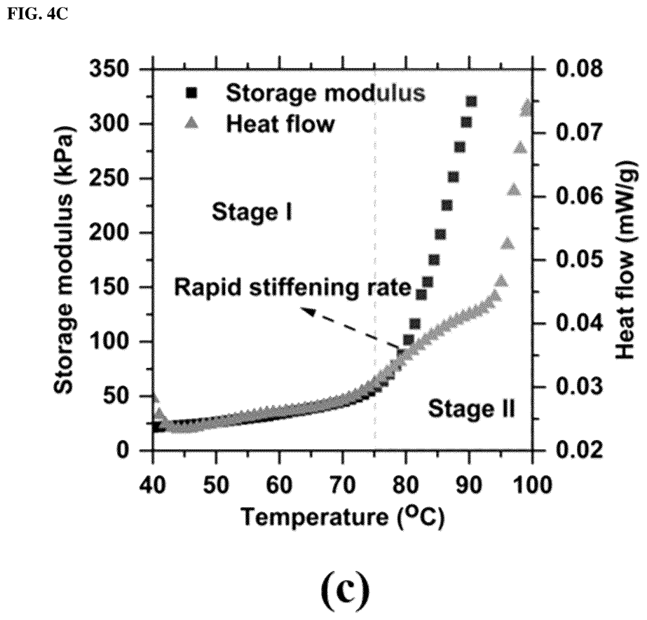

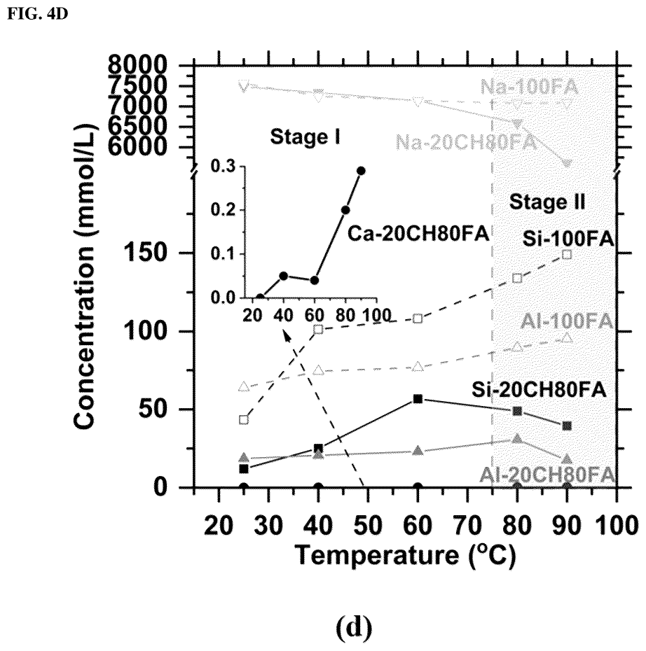

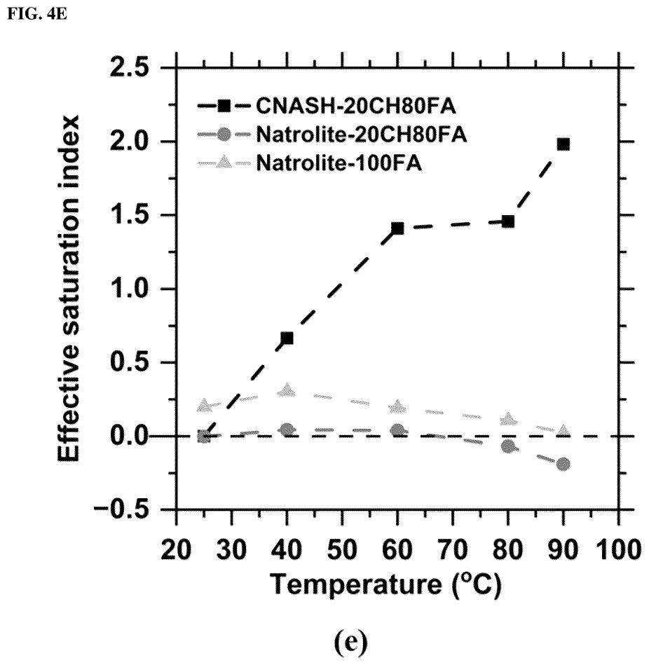

While not being bound by theory, the approximate linear increase of structural build-up in the CH-FA suspensions with increasing temperature in Stage 1 at relatively lower temperature (as seen in FIG. 3(a)) may be attributed to: 1) accelerated aggregation and the emergence of larger CH aggregates, attributable to the diminished electrostatic repulsion among CH particles, 2) the (very) slight increase in solid volume fraction due to the initial alkaline reaction of FA. The rapid increase of storage modulus in Stage 2 can be ascribed to the accelerated pozzolanic reaction between CH and FA and the alkaline activation of FA at temperatures above 75 °C. To further elucidate the temperature-induced stiffening mechanism of CH-FA suspensions, differential scanning calorimetry and pore solution chemistry analyses on specific suspensions (100FA_8M_0.44 and 20CH80FA_8M_0.44) were carried out and compared with the temperature-dependent SAOS measurements in FIG. 4. FIG. 4(a) shows the two-stage thermo-responsive stiffening of CH-FA suspensions. In contrast to the neat fly ash formulation (100FA), the 20CH80FA suspension showed a higher initial storage modulus and a faster structure development rate. Similarly, the DSC thermograms of 100FA and 20CH80FA exhibit two stages, as shown in FIGS. 4(b and c). Both 100FA and 20CH80FA suspensions showed lower heat flow at lower temperatures. This may indicate that the linear increase in this region is mainly attributable to the formation of aggregates due to the physical interaction of particles. However, an inflection point is seen at ~75 °C, with 20CH80FA displaying a notably rapid exothermic reaction, while the heat flow of 100FA was considerably lower. This may indicate that a chemical reaction takes place in the suspension 20CH80FA in this temperature range. The pore solution chemistry measurement shown in FIG. 4 provides additional crucial insights. Four different ions Si, Na, Al, and Ca were analyzed in the suspensions 20CH80FA and 100FA (Ca was not detected in the mixture 100FA). Na, unsurprisingly, is the most abundant (100FA and 20CH80FA) reaching around 7700 mmol/L at 25 °C. Na in the 100 FA suspension exhibited a gradual decline. Conversely, in the 20CH80FA suspension, Na concentrations reduced only modestly during Stage I, followed by a substantial and rapid decrease in Stage II. Si and Al ions were also detected in the pore solution resulting from the dissolution of the FA. The concentration of Si and Al in the 100FA suspension demonstrated a continuous increase as the temperature increased, reaching approximately 40-150 mmol/L for Si and 60-95 mmol/L for Al, while in the 20CH80FA suspension, there was an initial rise in Si and Al concentration followed by a rapid decline. This decline may be attributed to the consumption of these ions via the precipitation of reaction products. In the 20CH80FA suspension, a marginal rise in Ca concentration was noted with an increase in temperature from approximately 0 mmol/L to 0.3 mmol/L. Since FA (larger) and CH (smaller) have significantly different particle size distributions and surface areas, CH may bind to the FA particles during mixing, creating a layer on the FA particles. In Stage 2, FA particles dissolve releasing aluminum and silicon species that interact with OH—, Na+, and CaOH+ ions in solution. This process initially yields C-(A)-S—H type gels near the dissolving fly ash. Subsequently, as network-forming elements (Si and Al) diffuse out of the CH layer, (N, C)-A-S—H type gels are formed. OH— has been shown to hinder the dissolution of CH during Stage 1. The chemical reaction involving the creation of N-A-S—H leads to hydroxyl ion consumption, reducing pH levels, facilitating CH dissolution and promoting the formation of C-(A)-S—H compounds. Over time, as CH is depleted, the alkali activation process of FA becomes prominent, resulting in dominant N-A-S—H formation. Assessing the saturation indices through the pore solution concentrations provides an effective means of independently evaluating the potential formation or dissolution of solid phases. The effective saturation indices are depicted in FIG. 4(e). Positive SI values suggest that the solutions, for compounds including C—N-A-S—H and Na-containing zeolites, such as natrolite (Na₂Al₂Si₃O₁₀2H₂O), are consistently oversaturated, implying the possibility of precipitation of these solid phases. In the 20CH80FA suspension, both aluminosilicate and calcium aluminosilicate hydrates were evident, with calcium aluminosilicate hydrate being notably predominant across the temperature range, consistent with. Conversely, the 100FA suspension exclusively yielded aluminosilicate hydrate (Natrolite), aligning with previous findings.

### Reaction Kinetics, Strength, and Reaction Products of CH-FA Suspensions at Later Stages

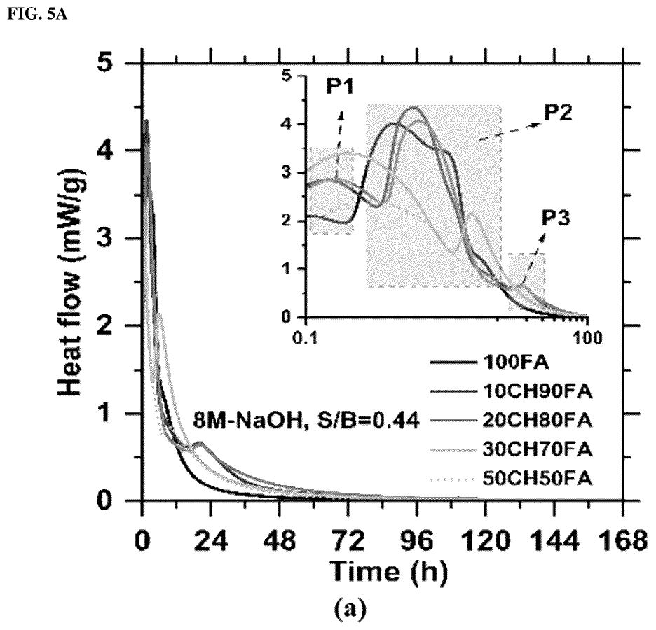

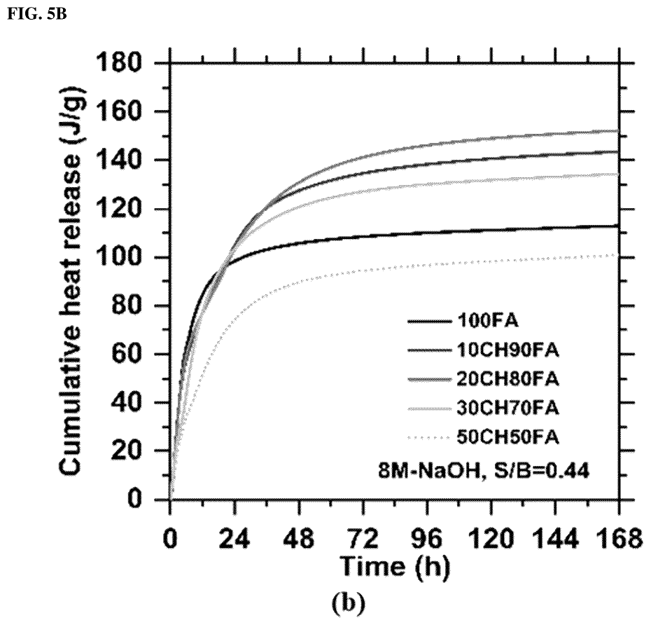

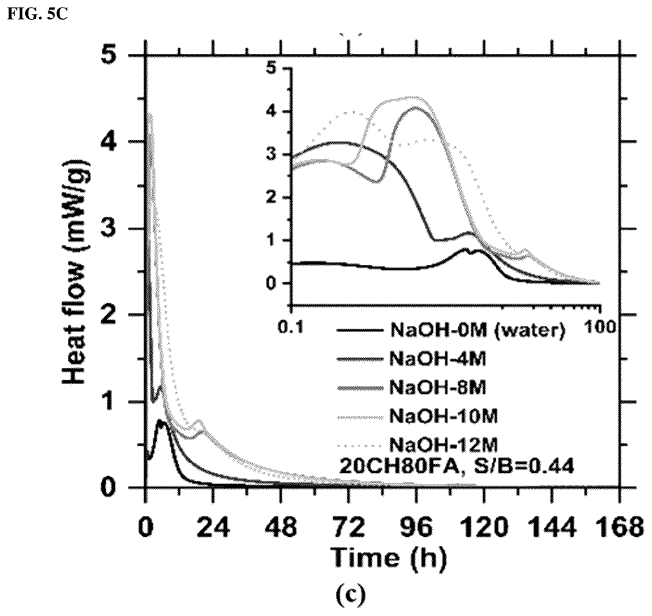

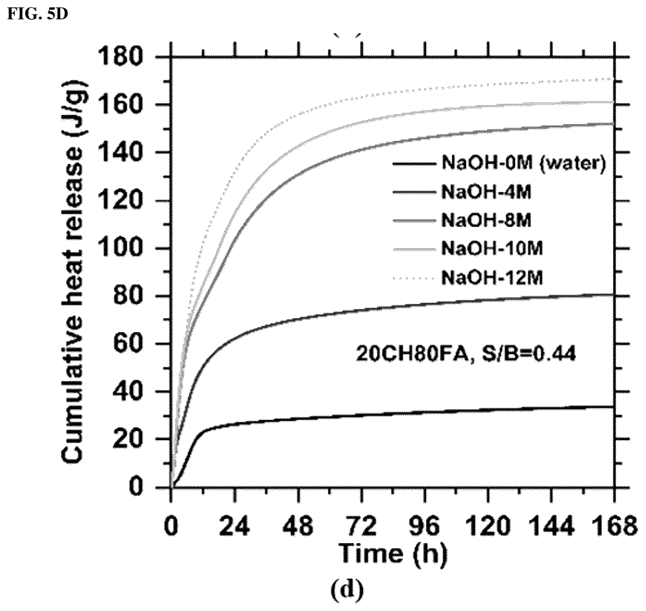

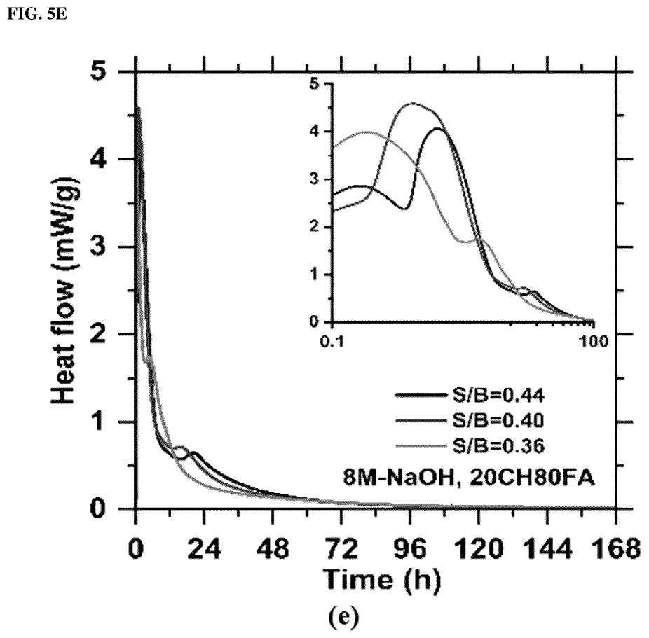

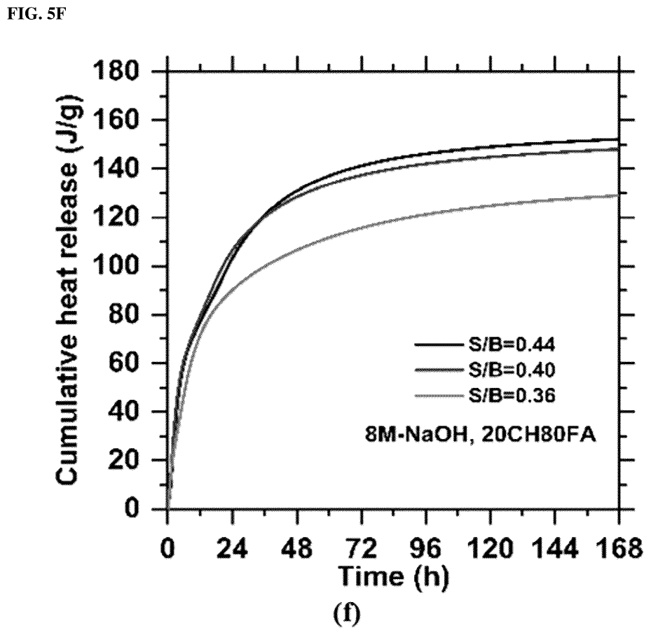

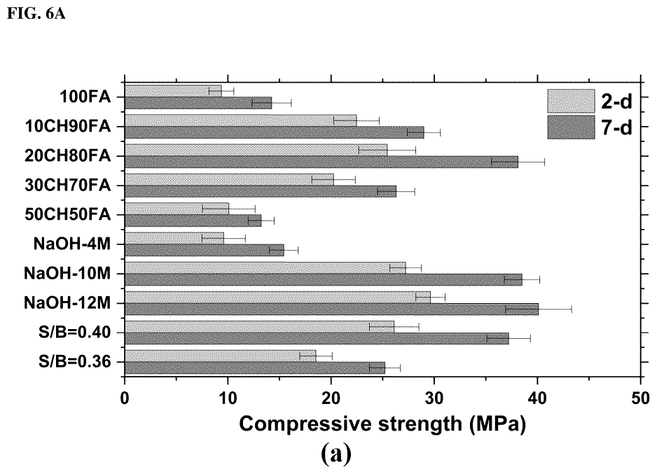

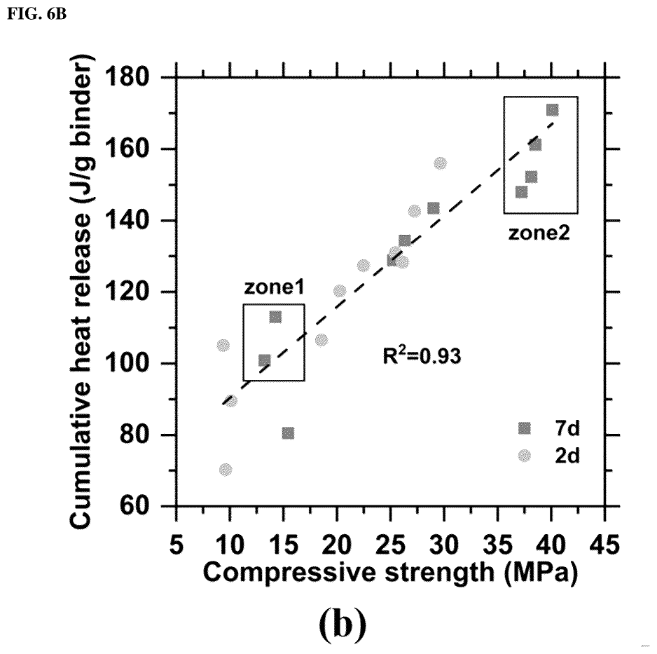

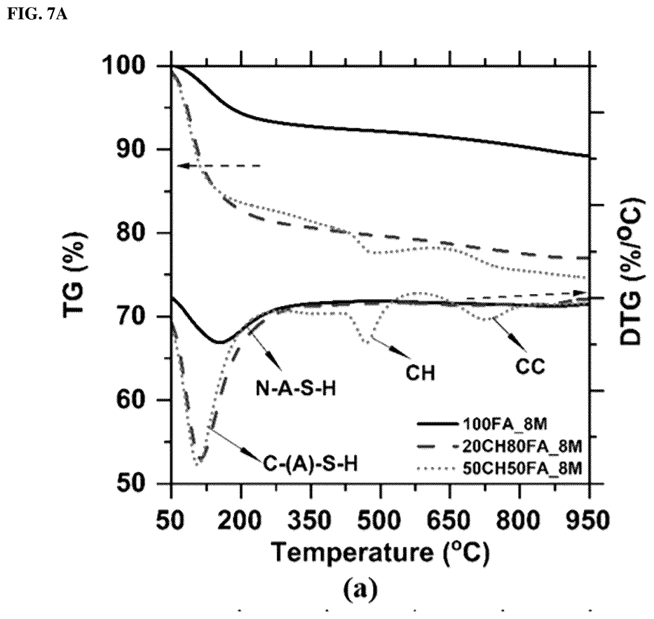

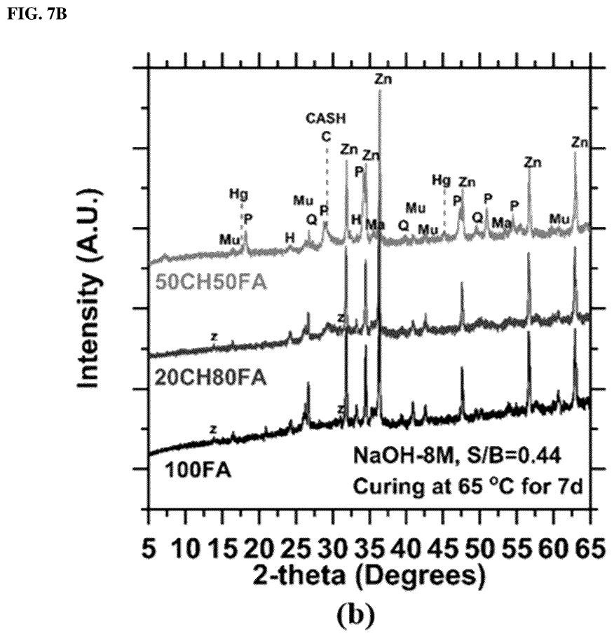

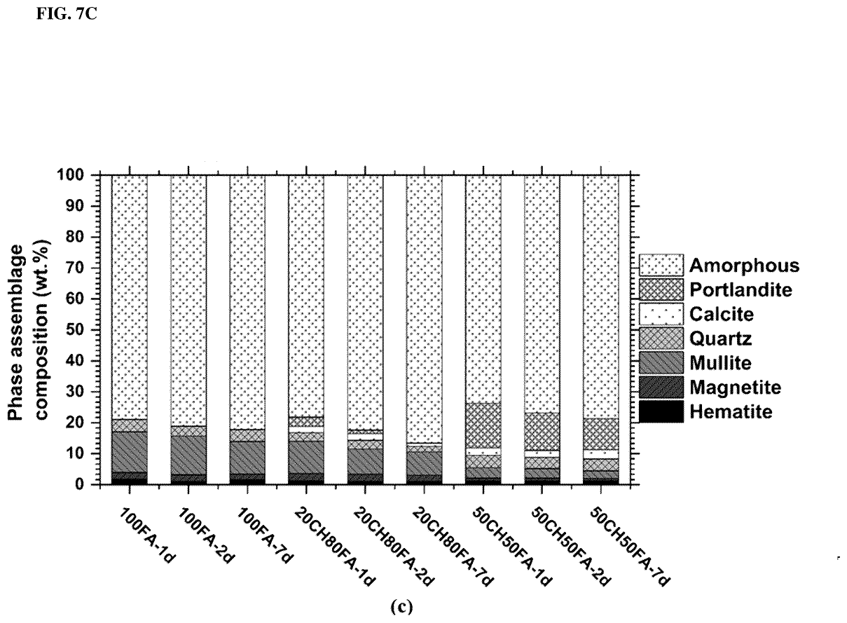

The reaction kinetics of the CH-FA mixture at 65 °C measured by isothermal calorimetry are presented in FIG. 5. The effect of CH additions on the heat flow and cumulative heat release of the CH-FA mixture is displayed in FIGS. 5(a and b), respectively. Typically, the CH-FA mixtures' heat flow curves exhibit two distinct calorimetric peaks. The initial peak, P1, may be attributed to the dissolution of fly ash (FA), while the subsequent peak, P2, may correspond to the precipitation of alkali-aluminosilicate hydrate and calcium aluminosilicate hydrate phases. For mixtures 10CH90FA and 20CH80FA, another peak, P3, was seen around 20 h. This may be attributed to the additional heat release resulting from the alkaline activation of fly ash once all CH has been exhausted. A smaller addition of CH resulted in increased hydration heat, as shown by 10CH90FA and 20CH80FA, compared to 100FA (FIG. 5(d)). Conversely, adding too much CH (e.g., 50CH50FA) decreases the release of hydration heat and impedes the pozzolanic reaction of FA. The effect of the NaOH concentration on heat flow and cumulative heat release is shown in FIGS. 5(c and d). The mixture formulation NaOH-OM showed a lower total heat release and a lower heat flow. On the other hand, a greater NaOH content increased the degree of reaction, which led to a larger cumulative heat release and a higher calorimetric peak intensity. The impact of s/b on the reaction kinetics of CH-FA suspension is depicted in FIGS. 5(e and f). The s/b ratios of 0.44 and 0.40 showed similar cumulative heat release, reaching around 150 J/g at 7 d. However, further reduction in the s/b ratio adversely affects the reaction, leading to a lower cumulative heat release. The compressive strength of the CH-FA formulations after 2 d and 7 d of aging is shown in FIG. 6(a). The compressive strength initially increases with CH dosage, reaching a peak of ~40 MPa after 7 d. However, the compressive strength declines as the CH dosage exceeds 20 mass % and falls below 15 MPa when the CH dosage is 50 mass % (at 7 d). This may suggest that an optimum amount of CH facilitates FA reactions. The compressive strength exhibited a positive correlation with the NaOH concentration, as an increase in NaOH concentration led to an increase in compressive strength. Nevertheless, compressive strength did not significantly improve with increasing NaOH concentration over 8 mol/L NaOH. Surprisingly, reducing the s/b ratio from 0.44 to 0.36 did not increase compressive strength in spite of a reduction in the porosity, in agreement with the calorimetric data. FIG. 6 (b) illustrates the relationship between compressive strength and cumulative heat release in CH-FA mixtures. The data shows a positive linear correlation, which may suggest that the compressive strength is influenced by the heat release from the pozzolanic reaction. Two distinct zones are evident: Zone 1 includes mixtures with either no CH or 50% CH, while Zone 2 comprises mixtures with 20% CH content. As previously mentioned, an optimal CH content results in both higher compressive strength and greater cumulative heat release. TGA and XRD analyses were carried out to examine the impact of CH addition on the reaction products (see FIG. 7). TGA traces (see FIG. 7(a)) show that increased CH addition resulted in increased mass loss following alkaline activation, consistent with earlier reports. For mixtures 100FA, 20CH80FA, and 50CH50FA at age of 7 d, the mass loss at 950 °C was 10.78 mass %, 23.02 mass %, and 25.38 mass %, respectively. The sole DTG peak for 100FA, centered around 150 °C, is attributable to N-A-S—H decomposition. In contrast, a DTG peak for mixtures 20CH80FA and 50CH50FA around 120 °C suggests the decomposition of C-A-S—H. These decompositions behaviors agree with those observed for C—S—H gels in cementitious systems and the C—(N—) A-S—H gel that has been reported in alkali-activated slag mixture and alkali-activated slag/fly ash systems. Furthermore, the mixture 50CH50FA showed two additional minor DTG peaks centered at 470 °C and 730 °C, indicating the dehydration of CH and the decarbonation of calcium carbonate (CC), respectively. This may indicate that a portion of CH is involved in the reaction with FA, while another portion undergoes carbonation, e.g., perhaps during sample preparation. No obvious peaks associated with the dehydration of CH and/or decarbonation of CC were observed in the mixture 20CH80FA, which may indicate that the majority of CH participated in the reaction of FA. FIG. 7(b) shows XRD reflections for the CH-FA formulations after 7 d of aging. For the mixtures 20CH80FA and 50CH50FA, a slight hump centered at 20=29.5° was found. This hump may indicate weakly crystalline C-A-S—H gel (PDF #89-6458), demonstrating the interaction between FA and CH, and is consistent with the TGA data, and previous studies. A weakly crystalline zeolite-type phase with natrolite-like structures was also seen in the mixtures 100FA and 20CH80FA containing 20 mass % CH, indicating the activation of FA. Additionally, the 50CH50FA mixture exhibited peaks at around 2θ=17.5° and 45°, related to the production of C3AH6. Given that the samples used in this investigation were cured at 65° for 7 d as in other studies, the present findings are consistent with these prior observations. To trace the consumption of CH, Rietveld refinement of the XRD reflections was carried out. The mineralogical composition encompassed mullite, quartz, hematite, magnetite, calcite, and portlandite (CH), with the remaining constituents consisting of an amorphous composition including unreacted FA, C-A-S—H, and N-A-S—H. FIG. 7(c) presents the mineralogy of the CH-FA mixtures with time. The CH-FA samples exhibited the presence of predominant crystalline phases, specifically mullite (ICDD PDF #00-015-0776) and quartz (PDF #01-079-1910), originating from FA. Minor crystalline phases, such as hematite (PDF #00-033-0664) and magnetite (PDF #00-039-1346), were also detected. The CH content decreased, and the amorphous phase content increased with time in the mixtures 20CH80FA and 50CH50FA. This may suggest that CH is consumed in the pozzolanic reaction with FA, resulting in the formation of C-A-S—H gel. The mixture containing 20 mass % CH (20CH80FA) showed little CH after 7 days, indicating that the development of N-A-S—H gel may largely depend on the alkaline reaction of fly ash. The amorphous content in the mixture 100FA also increased with time, suggesting that FA continued to react to produce the N-A-S—H gel (see also Table 4). The TGA and QXRD results were equal to each other within experimental uncertainty, as seen in Table 4.

TABLE 4
The evolution of the residual CH in the CH-FA mixtures determined
using TGA and QXRD.

| | CH content (mass %, | CH content (mass %, |
|---|---|---|
| Mixture notation | by TGA) | by QXRD) |
| 20CH80FA-1d | 3.9 ± 0.4 | 3.0 ± 0.8 |
| 20CH80FA-2d | 2.1 ± 0.5 | 1.2 ± 0.4 |
| 20CH80FA-7d | 1.0 ± 0.2 | — |
| 50CH50FA-1d | 16.5 ± 1.0 | 14.4 ± 1.8 |
| 50CH50FA-2d | 13.4 ± 1.2 | 12.2 ± 2.0 |
| 50CH50FA-7d | 11.1 ± 0.7 | 10.1 ± 2.1 |

### 3D-PRINTING Demonstration

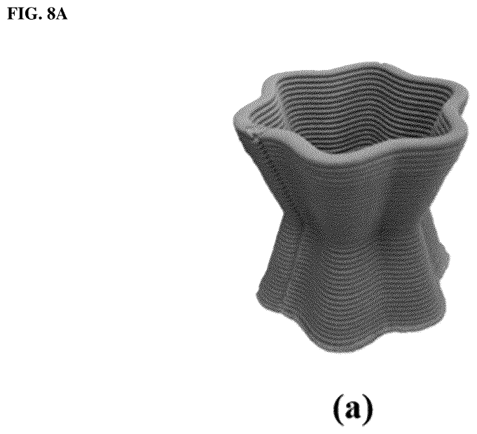

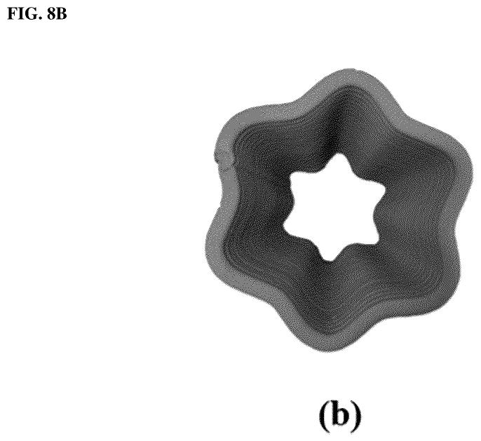

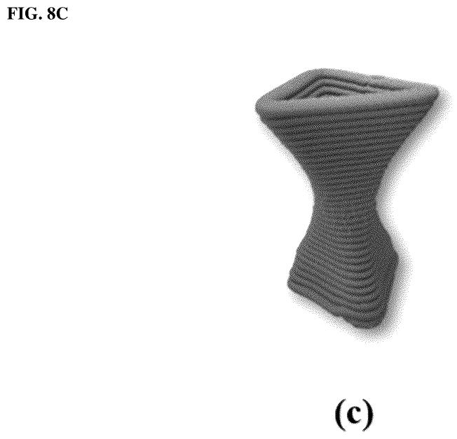

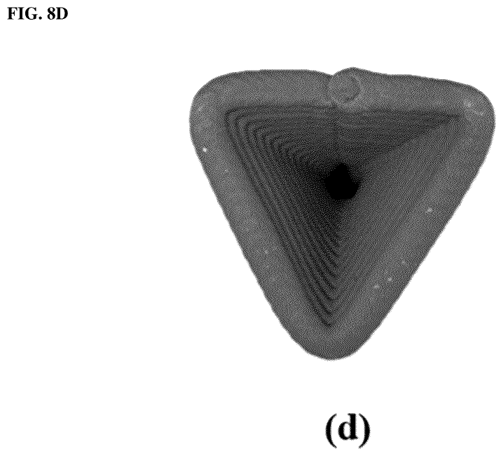

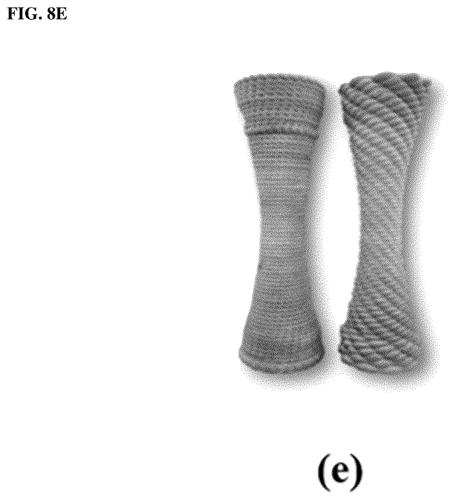

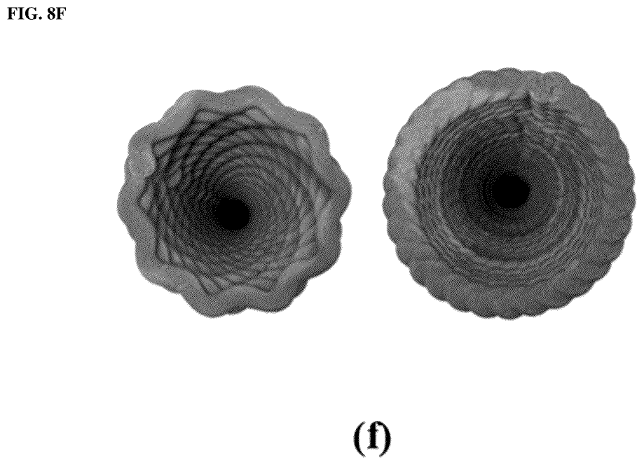

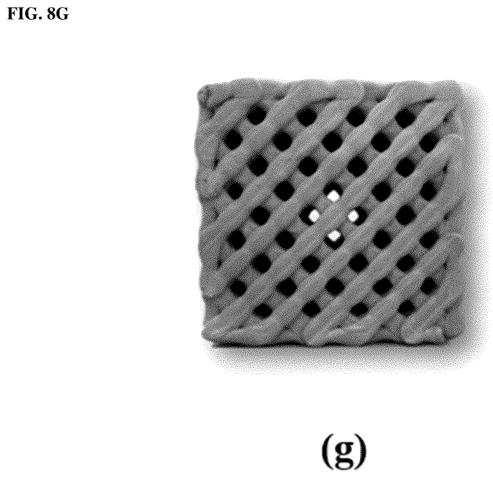

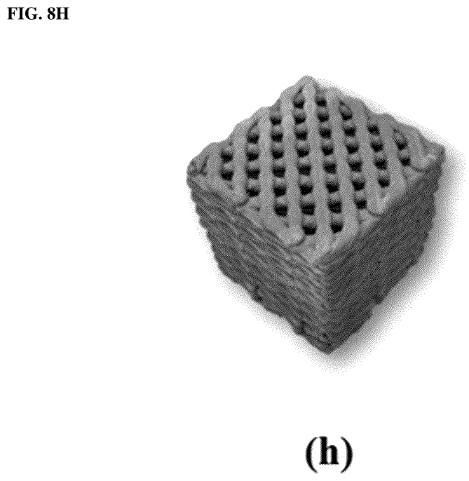

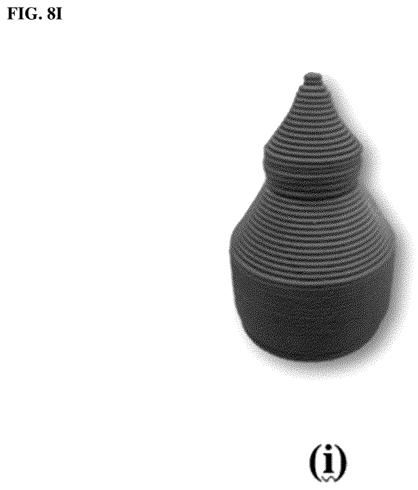

Based on its rheological properties and stiffening behavior (yield stress: 382±7 Pa, plastic viscosity: 3.1±0.2 Pas, and stiffening rate: 806±16 Pa/s), mixture 20CH80FA was selected for a 3D-printing demonstration because: 1) at ambient temperature, this composition exhibits favorable flowability and a low reaction rate, thereby providing sufficient “open time”, 2) during printing, when subjected to temperature stimulation, the mixture shows rapid stiffening, 3) during curing, the inclusion of CH significantly activates reactions with FA, resulting in a substantial increase in compressive strength. Precise regulation and careful optimization of multiple process parameters are crucial for successfully printing with these thermo-responsive slurries. Key parameters such as heating rate (150-200 °C with airflow of 24 liters/min) and print speed (25 mm/s) play a role in achieving the desired printability, stiffening rate, and interlayer bonding. The optimal stiffening kinetics of the slurries depend on the geometric complexity of the structure being printed. A well-designed mixture, combined with fine-tuned process parameters, allows for printing complex geometries with strong interlayer adhesion and high print fidelity. FIG. 8 shows that this mixture can be used to print complex print geometries with strong interlayer bonding and negligible cracking. While 3D printing has many advantages, including material efficiency, design flexibility, and cost savings, there remains an open question regarding the carbon intensity of 3D-printing formulations (“inks”). To further understand the embodied CO₂ of 3D printable CH-FA mixtures and compare them with OPC (ASTM Type 1) mixtures, the CO₂ emissions of 1 m³ of a 3D-printable CH-FA mixture and OPC concrete were calculated, assuming all mixtures had s/b=0.44 and a sand-to-binder mass ratio of 1). The embodied CO₂ emissions of one ton of OPC, FA, CH and NaOH are 766 kg CO₂/t, 27 kg CO₂/t, 270 kg CO₂/t, and 1120 kg CO₂/t, respectively. Based on the production of 1 m³ of a 3D-printable formulation, an OPC mixture is estimated to generate approximately 680 kgCO₂/m³, whereas the 20CH80FA mixture results in only 180 kgCO₂/m³. The carbon emission resulting from the heat required for curing the CH-FA mixture was also considered. This may imply that the embodied carbon intensity (eCI) of the CH-FA mixture is 73% lower than OPC, resulting in a substantially more carbon-efficient formulation.

The impact of Portlandite (CH) on the rheology, stiffening behavior, reaction kinetics, and phase of exemplary reaction products of CH-FA mixtures according to some embodiments of the invention has been discussed. While not being bound theory, one conclusion is that while CH-FA mixtures have a low structural build-up rate at ambient temperature, the structural build-up rate increases rapidly upon heating the suspension with a critical temperature of 75 °C. Through pore solution analysis, it was observed that, under temperature stimulation, fly ash reacts and dissolves rapidly. Furthermore, when the temperature exceeds 75 °C, dissolved ions from the fly ash combine with CH, forming C-A-S—H, consequently leading to much more rapid solidification of the suspension, thus enabling adequate strength development for the printing process with this material. This active thermally stiffening control enables 3D-printing operations. Another possible conclusion is that the addition of CH improves buildability during the 3D printing process based on temperature activation and enables FA activation to improve the hardened properties.

### DEFINITIONS

Unless otherwise defined herein, scientific and technical terms used in this application shall have the meanings that are commonly understood by those of ordinary skill in the art.

All of the above, and any other publications, patents and published patent applications referred to in this application are specifically incorporated by reference herein. In case of conflict, the present specification, including its specific definitions, will control.

As used herein, the term “controlled heating” refers to heating at a rate over a defined period of time, e.g., about 1 to about 10 °C/minute. In certain embodiments, the controlled heating is performed under an inert nitrogen atmosphere.

As used herein, the term “curing” refers to the process of altering a hydraulic cementitious or concrete mixture by heating the mixture to a “curing temperature”, thereby inducing chemical reaction(s) between any of the components of the mixture and/or the evaporation of water from the mixture to produce a solid, “cured” cement or concrete product.

As used herein, the term “binder” is used to generally describe any uncured hydraulic binding material that is used in concrete mixtures to produce a stable concrete product upon undergoing a curing process, as is well-known in the art. The term “cement” as used herein refers to the product produced by curing a cementitious precursor, binder or slurry. As a non-limiting example, Ordinary Portland Cement (OPC) or Normal Portland Cement is a common name used to describe a type of binder (either cured or uncured). OPC comprises essentially a dry component including (i) a “clinker” comprising calcareous materials and argillaceous materials that have been crushed to a desired grain size and heated to induce carbonation, and finely ground gypsum. When this dry component is mixed with a desired amount of water, a “cementitious slurry” or “cementitious precursor” is formed which “sets” upon drying or curing. During the setting or curing process, a complex set of chemical reactions occurs to produce a stable solid known in the art as “cement.”

As used herein, the term “slag” is an art-recognized term which refers to the waste products from ore-smelting operations, including, as a non-limiting example, slags produced during the production of steel (e.g., steel slags).

As used herein, the term “fly ash” art-recognized terms which refers to certain solid particulate byproducts of industrial coal combustion. Fly ash generally contains silica, alumina, iron oxide, and calcium, with varying amounts of carbon.

As used herein, the term “thermo-responsive” is an art-recognized term which refers to materials that exhibit changes to their physical properties when exposed to temperature changes.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method of producing a 3D-printed concrete product, comprising:
preparing a thermo-responsive suspension comprising a binder and an alkaline solution;
extruding the thermo-responsive suspension under controlled heating, thereby producing a 3D-printed structural component; and
curing the 3D-printed structural component, thereby producing a 3D-printed concrete product.

2-36. (canceled)

37. A thermo-responsive suspension comprising
a binder; and
an alkaline solution at an alkaline solution concentration,
wherein the alkaline solution and the binder in the thermo-responsive suspension have a mass ratio from about 0.2 to about 1; and
wherein the alkaline solution concentration is from about 4 molar to about 12 molar.

38. The thermo-responsive suspension of claim 37, further comprising a thermo-responsive additive.

39. The thermo-responsive suspension of claim 38, wherein the thermo-responsive additive is selected from monomers, crosslinking agents, initiators, water, dispersants, and any combination thereof.

40. The thermo-responsive suspension of claim 38, wherein the thermo-responsive additive is selected from acrylamide, trimethylolpropane trimethacrylate, 2,2′-Azobis[2-(2-imidazolin-2-yl) propane]dihydrochloride, polycarboxylate ether-based dispersant, and any combination thereof.

41. The thermo-responsive suspension of claim 37, wherein the binder comprises portlandite, fly ash, cement, slag, silica fume, quartz, limestone, or any combination thereof.

42. (canceled)

43. The thermo-responsive suspension of claim 41, wherein the binder comprises fly ash and portlandite, and the fly ash and portlandite comprise oxides.

44. (canceled)

45. (canceled)

46. The thermo-responsive suspension of claim 41, wherein the suspension comprises about 10% portlandite and about 90% fly ash by mass.

47. The thermo-responsive suspension of claim 41, wherein the suspension comprises about 20% portlandite and about 80% fly ash by mass.

48. The thermo-responsive suspension of claim 41, wherein the suspension comprises about 30% portlandite and about 70% fly ash by mass.

49. The thermo-responsive suspension of claim 41, wherein the suspension comprises about 50% portlandite and about 50% fly ash by mass.

50. The thermo-responsive suspension of claim 37, wherein the alkaline solution is sodium hydroxide.

51. The thermo-responsive suspension of claim 37, wherein the alkaline solution concentration is about 4 molar.

52. The thermo-responsive suspension of claim 37, wherein the alkaline solution concentration is about 8 molar.

53. The thermo-responsive suspension of claim 37, wherein the alkaline solution concentration is about 10 molar.

54. The thermo-responsive suspension of claim 37, wherein the alkaline solution concentration is about 12 molar.

55. The thermo-responsive suspension of claim 37, wherein the mass ratio is from about 0.3 to about 0.5.

56-58. (canceled)

59. The thermo-responsive suspension of claim 37, wherein the thermo-responsive formulation is a slurry.

60. The thermo-responsive suspension of claim 37, wherein the formulation is free of cement or essentially free of cement.

61. (canceled)

62. A 3D-printing system comprising:
a cementitious suspension feed;
an auger body;
a motor;
an extruder;
one or more heating elements; and
a nozzle head comprising a nozzle.
